(19) United States
(12) Patent Application Publication
(10) Pub. No.: US 2026/0246521 A1
(43) Pub. Date: Aug. 20, 2026

(54) EDGE COMPUTATION WITH DISTRIBUTED CODING

(71) Applicant: QUALCOMM Incorporated, San Diego, CA (US)

(72) Inventors: Amit BAR-OR TILLINGER, Tel-Aviv (IL); Gideon Shlomo KUTZ, Ramat Hasharon (IL)

(21) Appl. No.: 19/057,813

(22) Filed: Feb. 19, 2025

(51) Int. Cl. H04B 7/06; H04W 72/232

(52) U.S. Cl. CPC H04B 7/0634; H04W 72/232

(57) ABSTRACT

Methods, systems, and devices for wireless communications are described. A user equipment (UE) may receive information indicative of one or more coding coefficients from a network entity. The one or more coding coefficients may be associated with encoding a matrix. The UE may receive, via broadcast signaling, one or more sub-matrices of the matrix and a vector associated with a distributed computation operation. Each sub-matrix of the one or more sub-matrices may be received via a respective physical resource and may be identified according to the one or more coding coefficients. The UE may transmit a result vector in accordance with receiving the one or more sub-matrices. The UE may obtain the result vector according to a multiplication of a coded matrix and the vector, and the UE may obtain the coded matrix according to a combination of the one or more coding coefficients and the one or more sub-matrices.

### FIELD OF TECHNOLOGY

The following relates to wireless communications, including edge computation with distributed coding.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving information indicative of one or more coding coefficients of a set of multiple coding coefficients, where the set of multiple coding coefficients are associated with encoding a first matrix, receiving, via broadcast signaling, one or more sub-matrices of the first matrix and a vector, where each sub-matrix of the one or more sub-matrices is received via a respective physical resource, and where the one or more sub-matrices of the first matrix are identified according to the one or more coding coefficients, and transmitting a result vector in accordance with receiving the one or more sub-matrices, where the result vector is obtained according to a multiplication of a coded matrix and the vector, and where the coded matrix is obtained according to a combination of the one or more coding coefficients and the one or more sub-matrices.

A UE for wireless communications is described. The UE may include one or more memories storing processor executable code, and one or more processors coupled with the one or more memories. The one or more processors may individually or collectively be operable to execute the code to cause the UE to receive information indicative of one or more coding coefficients of a set of multiple coding coefficients, where the set of multiple coding coefficients are associated with encoding a first matrix, receive, via broadcast signaling, one or more sub-matrices of the first matrix and a vector, where each sub-matrix of the one or more sub-matrices is received via a respective physical resource, and where the one or more sub-matrices of the first matrix are identified according to the one or more coding coefficients, and transmit a result vector in accordance with receiving the one or more sub-matrices, where the result vector is obtained according to a multiplication of a coded matrix and the vector, and where the coded matrix is obtained according to a combination of the one or more coding coefficients and the one or more sub-matrices.

Another UE for wireless communications is described. The UE may include means for receiving information indicative of one or more coding coefficients of a set of multiple coding coefficients, where the set of multiple coding coefficients are associated with encoding a first matrix, means for receiving, via broadcast signaling, one or more sub-matrices of the first matrix and a vector, where each sub-matrix of the one or more sub-matrices is received via a respective physical resource, and where the one or more sub-matrices of the first matrix are identified according to the one or more coding coefficients, and means for transmitting a result vector in accordance with receiving the one or more sub-matrices, where the result vector is obtained according to a multiplication of a coded matrix and the vector, and where the coded matrix is obtained according to a combination of the one or more coding coefficients and the one or more sub-matrices.

A non-transitory computer-readable medium storing code for wireless communications is described. The code may include instructions executable by one or more processors to receive information indicative of one or more coding coefficients of a set of multiple coding coefficients, where the set of multiple coding coefficients are associated with encoding a first matrix, receive, via broadcast signaling, one or more sub-matrices of the first matrix and a vector, where each sub-matrix of the one or more sub-matrices is received via a respective physical resource, and where the one or more sub-matrices of the first matrix are identified according to the one or more coding coefficients, and transmit a result vector in accordance with receiving the one or more sub-matrices, where the result vector is obtained according to a multiplication of a coded matrix and the vector, and where the coded matrix is obtained according to a combination of the one or more coding coefficients and the one or more sub-matrices.

In some examples of the method, UEs, and non-transitory computer-readable medium described herein, the broadcast signaling includes a set of multiple sub-matrices that include the first matrix and the set of multiple sub-matrices include the one or more sub-matrices for the UE and one or more other sub-matrices applicable to one or more other UEs.

In some examples of the method, UEs, and non-transitory computer-readable medium described herein, the information indicative of the one or more coding coefficients includes a second vector, each element of the second vector may be associated with a respective coding coefficient of the set of multiple coding coefficients, and a value of each element of the second vector indicates whether a corresponding coding coefficient may be included in the one or more coding coefficients.

Some examples of the method, UEs, and non-transitory computer-readable medium described herein may further include operations, features, means, or instructions for computing the coded matrix based on a multiply-and-accumulate operation of the one or more coding coefficients and the one or more sub-matrices and computing the result vector based on multiplying a result of the multiply-and-accumulate operation with the vector.

In some examples of the method, UEs, and non-transitory computer-readable medium described herein, the information indicative of the one or more coding coefficients may be received via a medium-access control-control element (MAC-CE) message, a downlink control information (DCI) message, a radio-resource control message (RRC), or any combination thereof.

In some examples of the method, UEs, and non-transitory computer-readable medium described herein, receiving the information indicative of the one or more coding coefficients may include operations, features, means, or instructions for obtaining a coding matrix including the set of multiple coding coefficients and receiving an indication of one or more rows of the coding matrix that includes the one or more coding coefficients.

In some examples of the method, UEs, and non-transitory computer-readable medium described herein, the coding matrix may be obtained via a RRC message and the indication of the one or more rows may be received via a MAC-CE message, a DCI message, or both.

Some examples of the method, UEs, and non-transitory computer-readable medium described herein may further include operations, features, means, or instructions for receiving an indication of a mapping between each sub-matrix of the one or more sub-matrices and each respective physical resource, where each respective physical resource includes a set of time resources, a set of frequency resources, a set of spatial resources, or any combination thereof, and where receiving the one or more sub-matrices may be in accordance with the mapping.

Some examples of the method, UEs, and non-transitory computer-readable medium described herein may further include operations, features, means, or instructions for receiving an indication of a set of resources for transmitting the result vector, where the result vector may be transmitted via the set of resources.

In some examples of the method, UEs, and non-transitory computer-readable medium described herein, transmitting the result vector may include operations, features, means, or instructions for transmitting the result vector via a set of resources that may be derived according to a downlink resource allocation of the one or more sub-matrices, according to the one or more coding coefficients, or both.

Some examples of the method, UEs, and non-transitory computer-readable medium described herein may further include operations, features, means, or instructions for receiving, via control signaling, an indication of a mapping between the set of resources and the downlink resource allocation, where the set of resources may be derived in accordance with the mapping.

Some examples of the method, UEs, and non-transitory computer-readable medium described herein may further include operations, features, means, or instructions for transmitting a capability message indicative of whether the UE may be capable of performing coded distributed computing operations, where receiving the information indicative of the one or more coding coefficients may be based on transmitting the capability message.

In some examples of the method, UEs, and non-transitory computer-readable medium described herein, the capability message includes a capability level of the UE, the capability level based on a computational capability of the UE, a storage capability of the UE, or both and a quantity of the one or more coding coefficients may be based on the capability level.

A method for wireless communications by a network entity is described. The method may include outputting, to each UE of a set of multiple UEs, information indicative of one or more respective coding coefficients of a set of multiple coding coefficients, where the set of multiple coding coefficients are associated with encoding a first matrix, outputting, via broadcast signaling, a set of multiple sub-matrices that include the first matrix and a vector, where each sub-matrix of the set of multiple sub-matrices is output via a respective physical resource, and obtaining, from one or more UEs of the set of multiple UEs, a respective result vector in accordance with outputting the set of multiple sub-matrices, where each respective result vector includes a multiplication of a coded matrix and the vector, and where each coded matrix is associated with a combination of the one or more respective coding coefficients and one or more sub-matrices.

A network entity for wireless communications is described. The network entity may include one or more memories storing processor executable code, and one or more processors coupled with the one or more memories. The one or more processors may individually or collectively be operable to execute the code to cause the network entity to output, to each UE of a set of multiple UEs, information indicative of one or more respective coding coefficients of a set of multiple coding coefficients, where the set of multiple coding coefficients are associated with encoding a first matrix, output, via broadcast signaling, a set of multiple sub-matrices that include the first matrix and a vector, where each sub-matrix of the set of multiple sub-matrices is output via a respective physical resource, and obtain, from one or more UEs of the set of multiple UEs, a respective result vector in accordance with outputting the set of multiple sub-matrices, where each respective result vector includes a multiplication of a coded matrix and the vector, and where each coded matrix is associated with a combination of the one or more respective coding coefficients and one or more sub-matrices.

Another network entity for wireless communications is described. The network entity may include means for outputting, to each UE of a set of multiple UEs, information indicative of one or more respective coding coefficients of a set of multiple coding coefficients, where the set of multiple coding coefficients are associated with encoding a first matrix, means for outputting, via broadcast signaling, a set of multiple sub-matrices that include the first matrix and a vector, where each sub-matrix of the set of multiple sub-matrices is output via a respective physical resource, and means for obtaining, from one or more UEs of the set of multiple UEs, a respective result vector in accordance with outputting the set of multiple sub-matrices, where each respective result vector includes a multiplication of a coded matrix and the vector, and where each coded matrix is associated with a combination of the one or more respective coding coefficients and one or more sub-matrices.

A non-transitory computer-readable medium storing code for wireless communications is described. The code may include instructions executable by one or more processors to output, to each UE of a set of multiple UEs, information indicative of one or more respective coding coefficients of a set of multiple coding coefficients, where the set of multiple coding coefficients are associated with encoding a first matrix, output, via broadcast signaling, a set of multiple sub-matrices that include the first matrix and a vector, where each sub-matrix of the set of multiple sub-matrices is output via a respective physical resource, and obtain, from one or more UEs of the set of multiple UEs, a respective result vector in accordance with outputting the set of multiple sub-matrices, where each respective result vector includes a multiplication of a coded matrix and the vector, and where each coded matrix is associated with a combination of the one or more respective coding coefficients and one or more sub-matrices.

Some examples of the method, network entities, and non-transitory computer-readable medium described herein may further include operations, features, means, or instructions for obtaining a computation result vector using each respective result vector obtained from the one or more UEs and a decoding matrix, where obtaining the computation result vector may be in accordance with a quantity of obtained result matrices satisfying a threshold.

In some examples of the method, network entities, and non-transitory computer-readable medium described herein, the information indicative of the one or more respective coding coefficients includes a second vector, each element of the second vector may be associated with a respective coding coefficient of the set of multiple coding coefficients, and a value of each element of the second vector indicates whether a corresponding coding coefficient may be associated with a UE of the set of multiple UEs.

In some examples of the method, network entities, and non-transitory computer-readable medium described herein, the information indicative of the one or more respective coding coefficients may be output via a MAC-CE message, a DCI message, a radio-resource control message, or any combination thereof.

In some examples of the method, network entities, and non-transitory computer-readable medium described herein, outputting the information indicative of the one or more respective coding coefficients may include operations, features, means, or instructions for outputting a coding matrix including the set of multiple coding coefficients and outputting an indication of one or more rows of the coding matrix that includes the one or more respective coding coefficients.

In some examples of the method, network entities, and non-transitory computer-readable medium described herein, the coding matrix may be output via a RRC message and the indication of the one or more rows may be output via a MAC-CE message, a DCI message, or both.

Some examples of the method, network entities, and non-transitory computer-readable medium described herein may further include operations, features, means, or instructions for outputting an indication of a mapping between each sub-matrix of the set of multiple sub-matrices and each respective physical resource, where each respective physical resource includes a set of time resources, a set of frequency resources, a set of spatial resources, or any combination thereof, and where outputting the set of multiple sub-matrices may be in accordance with the mapping.

Some examples of the method, network entities, and non-transitory computer-readable medium described herein may further include operations, features, means, or instructions for outputting an indication of a set of multiple sets of resources for each respective result vector, where the respective result vector may be obtained via a set of resources of the set of multiple sets of resources.

In some examples of the method, network entities, and non-transitory computer-readable medium described herein, obtaining the respective result vector from the one or more UEs may include operations, features, means, or instructions for obtaining, from a first UE of the set of multiple UEs, a first result vector via a first set of resources that may be according to a first downlink resource allocation of one or more first sub-matrices associated with the first UE, according to one or more first respective coding coefficients associated with the first UE, or both.

Some examples of the method, network entities, and non-transitory computer-readable medium described herein may further include operations, features, means, or instructions for outputting, via control signaling and to the first UE, an indication of a mapping between the first set of resources and the first downlink resource allocation.

Some examples of the method, network entities, and non-transitory computer-readable medium described herein may further include operations, features, means, or instructions for obtaining, from each UE of the set of multiple UEs, a capability message indicative of whether each UE may be capable of performing coded distributed computing operations, where outputting the information indicative of the one or more respective coding coefficients may be based on obtaining the capability message.

In some examples of the method, network entities, and non-transitory computer-readable medium described herein, the capability message includes a capability level of each UE of the set of multiple UEs, the capability level based on a computational capability of each UE, a storage capability of each UE, or both and a quantity of the one or more respective coding coefficients may be based on the capability level.

In some examples of the method, network entities, and non-transitory computer-readable medium described herein, a quantity of the set of multiple UEs may be greater than a quantity of the set of multiple sub-matrices of the first matrix.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports edge computation with distributed coding in accordance with one or more aspects of the present disclosure.

FIG. 2 shows an example of a wireless communications system that supports edge computation with distributed coding in accordance with one or more aspects of the present disclosure.

FIG. 3 shows an example of a process flow that supports edge computation with distributed coding in accordance with one or more aspects of the present disclosure.

FIGS. 4 and 5 show block diagrams of devices that support edge computation with distributed coding in accordance with one or more aspects of the present disclosure.

FIG. 6 shows a block diagram of a communications manager that supports edge computation with distributed coding in accordance with one or more aspects of the present disclosure.

FIG. 7 shows a diagram of a system including a device that supports edge computation with distributed coding in accordance with one or more aspects of the present disclosure.

FIGS. 8 and 9 show block diagrams of devices that support edge computation with distributed coding in accordance with one or more aspects of the present disclosure.

FIG. 10 shows a block diagram of a communications manager that supports edge computation with distributed coding in accordance with one or more aspects of the present disclosure.

FIG. 11 shows a diagram of a system including a device that supports edge computation with distributed coding in accordance with one or more aspects of the present disclosure.

FIGS. 12 through 15 show flowcharts illustrating methods that support edge computation with distributed coding in accordance with one or more aspects of the present disclosure.

### DETAILED DESCRIPTION

Some wireless communications systems may implement distributed computing schemes to reduce computational complexity at a device (e.g., a network entity). Such schemes may include distributing portions of a computation across multiple other devices (e.g., one or more user equipments (UEs)). For instance, a network entity may be tasked to perform a computation operation (e.g., multiplication, addition, or some other computation) using a relatively large matrix (e.g., A) and a vector (e.g., b). To reduce computation complexity, the network entity may divide the large matrix into multiple “sub-matrices” (e.g., A₀, A₁, A₂, and so on) and may employ (e.g., delegate) one or more UEs to perform a respective portion of the computation using one or more sub-matrices and the vector. However, in some cases, one or more of the employed UEs (e.g., stragglers, straggling UEs) may fail to perform (e.g., and/or to report) their respective portions of the computation, which may lead to failures in the distributed computing scheme. Further, in some other cases, some of the employed UEs (e.g., stragglers, straggling UEs) may fail to perform their respective portions of the computation in a timely manner (e.g., perform the computations with increased latency, fail to perform their computations fast enough), leading to a scenario in which the network entity may wait until each of the employed UEs reports their respective portions of the computation, which may increase latency within the distributed computing scheme.

To compensate for the straggling UEs (e.g., stragglers), a wireless communication system may implement a coded distributed computing (CDC) scheme. The CDC scheme may encode each computation portion such that a missing portion (e.g., based on a UE failure, or some other error) may be recovered via a combination of some other received portion(s) (e.g., a missing result, Q₂, may be recovered from received results, Q₀ and Q₁ via Q₂=Q₀+Q₁). However, these encoding operations may consume additional processing resources at the network entity and constrain system performance, which may offset the performance gains by the computational distribution across multiple UEs (e.g., edge nodes). Moreover, to support such techniques, the network entity may transmit coded matrix data and vector data (e.g., a vector, b, associated with the computation) multiple times to each UE, which may further consume processing resource and increase signaling overhead.

In accordance with one or more aspects described herein, a wireless communication system may distribute encoding operations and computation operations across one or more devices (e.g., one or more UEs). For example, a network entity may broadcast each component of a computation operation (e.g., one or more sub-matrices {A₀, A₁, . . . , Aₖ₋₁} and a vector {b}) to one or more UEs (e.g., all UEs employed for the computation). In some examples, each UE may identify the sub-matrices applicable to its assigned operations based on one or more coding coefficients (e.g.,

$${c}_{i}^{j} ,$$

received from the network entity). Each UE may obtain (e.g., compute, calculate) a coded matrix (e.g., Qⱼ) based on the coding coefficients and the sub-matrices, and may multiply the coded matrix by the received vector (e.g., b) to obtain a result vector (e.g., zⱼ=Qⱼ·b), which may be transmitted to the network entity. Based on the result vectors received from the UEs, the network entity may obtain an overall (e.g., a final) computation result.

By applying one or more techniques herein, the wireless communication system may support improved edge computation capabilities (e.g., improved reliability using CDC) with reduced impact to computational complexity at a network device. Such techniques may, for example, enable the wireless communication system to support relatively more complex operations (e.g., arithmetic operations) associated with data intensive applications such as artificial intelligence (AI) or machine learning (ML) applications. Additionally, the described techniques may enable the devices of the wireless communication system to reduce signaling traffic associated with edge computation, thereby increasing spectral efficiency and reducing power consumption. Further, by implementing the CDC scheme in addition to the techniques described herein, the network entity may decode (e.g., obtain) the overall (e.g., final) computation result as soon as a threshold quantity of employed UEs complete their tasks, which may enable the network entity to compensate for UEs that fail to report their respective results and enable the network entity to ignore the straggler UEs (e.g., even if such straggler UEs send their correct output at some point).

Aspects of the disclosure are initially described in the context of wireless communications systems. Aspects of the disclosure are further illustrated by and described with reference to process flows, apparatus diagrams, system diagrams, and flowcharts that relate to edge computation with distributed coding.

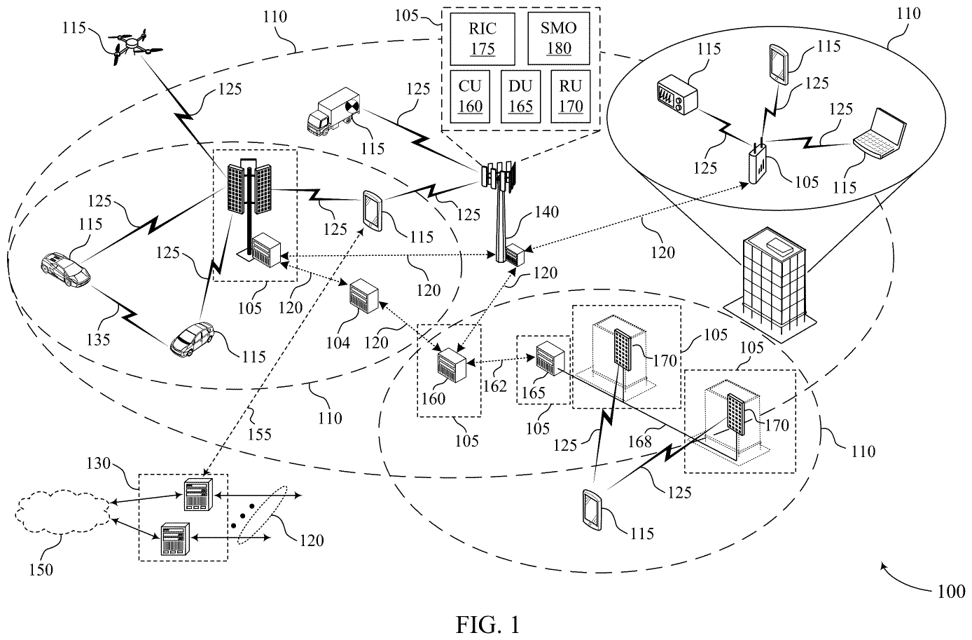

FIG. 1 shows an example of a wireless communications system 100 that supports edge computation with distributed coding in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support edge computation with distributed coding as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may utilize distributed computing schemes and CDC schemes to reduce computational complexity at a device (e.g., a network entity 105, a UE 115). Such schemes may include distributing portions of a computation across multiple other devices (e.g., one or more UEs 115, one or more network entities 105). For instance, a network entity 105 may be tasked to perform a computation operation (e.g., matrix multiplication) based on a relatively large matrix (e.g., A) and a vector (e.g., b). Rather than performing the entire computation at the network entity 105, the network entity may divide the large matrix into multiple “sub-matrices” (e.g., A₀, A₁, A₂, and so on) and may employ one or more UEs 115 to respectively perform a portion of the computation. To compensate for potential failures, the wireless communications system 100 may implement CDC schemes to recover one or more missing portions of the computation. However, these encoding operations may consume additional processing resources at the network entity 105, which may offset the benefit of employing UEs 115 for computational distribution. Moreover, to support such techniques, the network entity 105 may transmit a coded matrix and a vector (e.g., a vector associated with the computation) multiple times to each UE 115, which may further consume processing resource and increase signaling overhead.

In accordance with one or more aspects described herein, the wireless communications system 100 (e.g., a network entity 105, a UE 115) may implement one or more coding schemes and computation schemes that distribute encoding operations as well as the computation operations across multiple devices (e.g., one or more UEs 115, one or more network entities 105). For example, a network entity 105 may broadcast each component of a computation operation to multiple (e.g., all) employed UEs 115. In some examples, each UE 115 may identify the sub-matrices for its own assigned operations using one or more coding coefficients (e.g., cᵢ^{j}, received from the network entity 105). Each UE may obtain a coded matrix using the sub-matrices and the coding coefficients, and may multiply the coded matrix by a received vector to obtain a result vector, which the UE 115 may transmit to the network entity 105. Based on receiving the vectors from the UEs 115, the network entity 105 may obtain the overall computation result. Thus, the wireless communications system 100 may support improved edge computation capabilities, which may enable support for data intensive applications such as AI or ML applications, may reduce signaling traffic, and provide other benefits.

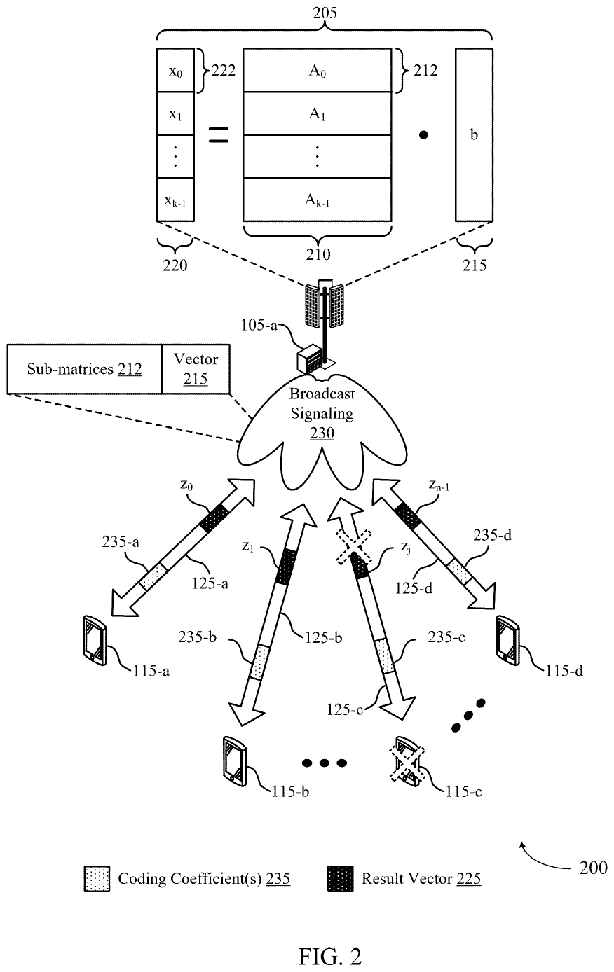

FIG. 2 shows an example of a wireless communications system 200 that supports edge computation with distributed coding in accordance with one or more aspects of the present disclosure. The wireless communications system 200 may implement or be implemented by aspects of the wireless communications system 100 as described herein. For example, the wireless communications system 200 may include a network entity 105-a and one or more UEs 115, which may be examples of, or include corresponding devices, or other devices as described herein with reference to FIG. 1.

The network entity 105-a may communicate with the one or more UEs 115 via respective links 125 (e.g., link 125-a, link 125-b, link 125-c, link 125-d), which may be examples of, or include, downlink communication interfaces, uplink communication interfaces, or other communication interfaces. Although a network entity 105-a and UEs 115 are shown as example devices of the wireless communications system 200, the techniques herein may be applied by one or more other devices described herein, including with reference to FIG. 1. In the non-limiting example of FIG. 2, the wireless communications system 200 may illustrate a network entity 105-a, a UE 115-a (e.g., UE₀), a UE 115-b (e.g., UE₁), a UE 115-c (e.g., UEⱼ), and a UE 115-d (e.g., UEₙ₋₁). However, the techniques described herein may be generally applicable to systems that include any quantity of network entities 105 and/or UEs 115.

The wireless communications system 200 may support distributed edge computation mechanisms. Using such mechanisms, a relatively large computational task (e.g., involving a relatively large quantity of arithmetic operations) at the network entity 105-a (e.g., such as matrix-vector multiplication) may be divided to multiple independent sub-tasks to be processed across the UEs 115. For example, the network entity 105-a may be tasked to perform an operation 205. As a non-limiting example, the operation 205 may include a multiplication of a matrix 210 (e.g., A) and one or more vectors 215 (e.g., b, or one or more vectors 215) to obtain a computation result vector 220 (e.g., x, or a result matrix, an overall or final computation result). The network entity 105-a may divide (e.g., partition, segment) the matrix 210 into one or more sub-matrices 212 (e.g., into k sub-matrices) such that the computation result vector 220 is a combination (e.g., concatenation) of the multiplication of the sub-matrices 212 by the vector 215 (e.g., a concatenation of result elements 222).

In some cases, the network entity 105-a may transmit a sub-matrix 212 and the vector(s) 215 to a respective UE 115 (e.g., Aⱼ and b are transmitted to UE 115-a, A₁ and b are transmitted to UE 115-b, Aⱼ and b are transmitted to UE 115-c, Aₖ₋₁ and b are transmitted to UE 115-a, and so on). Each UE 115 may multiply the received sub-matrix 212 by the vector 215 and may transmit a result to the network entity 105-a (e.g., UE 115-a may transmit x₀, UE 115-b may transmit x₁, UE 115-c may transmit xⱼ, UE 115-d may transmit xₖ₋₁, and so on). However, one or more UEs 115 may fail to perform their portion of the operation 205 or fail to report their respective results to the network entity 105-a in a timely manner (e.g., fail to report their respective results in a fast enough time, report their respective results with increased latency). In one case, the UE 115-c (e.g., a “straggling” UE) may experience unpredicted computational overloading, unfavorable channel conditions, or some other impediment that prevents the UE 115-c from obtaining and/or transmitting the result (e.g., xⱼ). In another case, the UE 115-c may experience the unpredicted computation overloading (or some other impediment) that may lead to the UE 115-c reporting the associated result (e.g., xⱼ) with increased latency (e.g., not in a timely manner), leading to the network entity 105-a to have to stall the evaluation of the final result (and the following operations that may be dependent on the final result) until the UE 115-c reports the associated result. In such cases, the network entity 105-a may experience increased latency within the distributed coding scheme. As such, the UEs 115 (e.g., the straggling UEs) may adversely impact (e.g., dictate) task latency and subsequent (e.g., dependent) tasks.

To mitigate such effects (e.g., straggler device induced delays), a system (e.g., the wireless communications system 200, a wired communication system) may implement a CDC scheme. For instance (e.g., to mitigate a worst-case straggler scenario), the network entity 105-a may add a conservative computation redundancy (e.g., may employ n UEs 115 instead of k, where n>k). That is, the quantity of UEs 115 (e.g., n) utilized for the CDC scheme may be greater than the quantity of sub-matrices 212 (e.g., k). Such CDC mechanisms may be implemented such that a relatively low (e.g., minimal) amount of redundant computation is performed, regardless of the delay pattern of the UEs 115 (e.g., may performed in a more-efficient manner compared to repetition). Various erasure codes (e.g., maximum-distance separable (MDS) codes), may be considered (e.g., utilized) to support the CDC scheme. As an illustrative example, if k=2, n=3, Q₀=A₀, Q₁=A₁, the network entity 105-a may be able to derive a coding matrix, Q₂, based on a combination of Q₀ and Q₁ (e.g., Q₂=Q₀+Q₁).

In some cases, the network entity 105-a may calculate “n” coded sub-matrices (e.g., derived from the sub-matrices 212 of the matrix 210) in accordance with Equation 1 (e.g., where

$${c}_{i}^{j}$$

represents a set of one or more coding coefficients and Aᵢ represents a sub-matrix 212).

$${Q}_{j} = {\sum }_{i = 0}^{k - 1} {c}_{i}^{j} {A}_{i} j = 0 , 1 , … , n - 1 \qquad ( 1 )$$

The network entity 105-a may transmit a coded sub-matrix, Qⱼ, and the vector 215 to each UE 115 (e.g., Q₀ and b are transmitted to UE 115-a, Q₁ and b are transmitted to UE 115-b, and so on). Each UE 115 may multiply the coded sub-matrix by the vector 215 to obtain a result vector 225 (e.g., zⱼ, where zⱼ=Qⱼ·b, multiplication results). The UEs 115 may transmit their respective result vectors 225 to the network entity 105-a. Accordingly (e.g., after a sufficient quantity of replies are received), the network entity 105-a may obtain the computation result vector 220 (e.g., may decode the results) in accordance with Equation 2 (e.g., where Dⱼ represents a decoding matrix).

$$x = {\sum }_{j = 0 , j ∉ S}^{n - 1} {D}_{j} \cdot {z}_{j} \qquad ( 2 )$$

However, some CDC methods may constrain a processing performance of the network entity 105-a. For instance, the network entity 105-a may perform a majority (e.g., or an entirety) of the encoding operation (e.g., the network entity 105-a may compute a majority of, or all of, the “n” coded sub-matrices, Qⱼ), which may introduce a processing bottleneck that offsets a value of employing multiple UEs 115 in parallel as distributed computational nodes. Moreover, some methods be associated with increased communication and signaling overhead. For instance, the network entity 105-a may transmit “n” coded sub-matrices and the vector 215 “n” times to each UE 115. As such, the wireless communications system 200 may experience reduced performance based on increased latency, decreased data rates, and increased power consumption.

In accordance with various aspects described herein, the wireless communications system 200 may support edge computation schemes and/or CDC schemes that improve a performance of the edge computation. In some examples, the wireless communications system 200 may implement a modified CDC scheme that exploits a wireless network physical layer to improve the edge computation. For example, the wireless communications system 200 (e.g., the network entity 105-a) may distribute an encoding computation between one or more UEs 115 based on broadcast signaling 230. The network entity 105-a may broadcast (e.g., multicast, in one or more transmissions) one or more sub-matrices 212 (e.g., “k” uncoded matrices) and the vector 215 (e.g., for a (k, n) code). Such distributed coding (e.g., distributed coding for wireless CDC for edge computation) may support more-efficient computation and communication mechanism by reducing a processing burden at the network entity 105 and by reducing wireless signaling traffic.

In some examples, the network entity 105-a may transmit (e.g., output, convey, provide, broadcast, multicast) broadcast signaling 230 that includes one or more sub-matrices 212 (e.g., all “k” sub-matrices) and the vector 215 (e.g., b, the network entity 105-a may broadcast the set {A₀, A₁, . . . , Aₖ₋₁, b}) to one or more UEs 115 (e.g., to all UEs 115). Each UE 115 may detect its relevant sub-matrices 212 applicable for its (e.g., assigned) encoding operation (e.g., based on one or more coding coefficients 235). For example, the network entity 105-a may transmit an indication (e.g., per UE 115) of one or more coding coefficients 235 (e.g.,

$${c}_{i}^{j} ) .$$

For instance, the network entity 105-a may indicate one or more coding coefficients 235-a to the UE 115-a, one or more coding coefficients 235-b to the UE 115-b, one or more coding coefficients 235-c to the UE 115-c, one or more one or more coding coefficients 235-d to the UE 115-d, and so on.

Each set of coding coefficients 235 (e.g., coding coefficients 235-a through 235-d) may be at least partially different than at least one other set of coding coefficients (e.g., the coding coefficients 235-a may be at least partially different than coding coefficients 235-b). In some examples, the one or more coding coefficients 235 may be communicated via MAC-control element (MAC-CE) signaling, downlink control information (DCI) message signaling, RRC signaling, or some other signaling (e.g., via respective links 125). In some examples, the UEs 115 may identify (e.g., specify) the coding coefficients 235 based on a coding matrix (e.g., or a family of multiple matrices), which may be defined in an industry standard (e.g., and stored at each UE 115 or otherwise obtained by each UE 115). Additionally, or alternatively, the network entity 105-a may indicate a coding matrix to each UE 115 via an RRC message. In such examples, the network entity 105-a may indicate (e.g., specify) one or more entries (e.g., one or more rows, one or more columns) of the coding matrix to be used by each UE 115 via a MAC-CE message or a DCI message.

In some examples, each set of coding coefficients 235 may include a vector, where one or more of the vector elements include non-zero entries. For each element with a non-zero entry, the corresponding UE 115 may receive the corresponding sub-matrix 212. For example, if the UE 115-a receives a coefficient

$${c}_{0}^{0} = 1$$

(e.g., included as part of a vector of received coefficients

$${c}_{i}^{0} ) ,$$

the UE 115-a may receive (e.g., process) the sub-matrix A₀. Additionally, in the same example, if

$${c}_{1}^{0} = 0 ,$$

the UL 115-a may not receive (e.g., or process) the sub-matrix A₁ (e.g., or the UE 115-a may perform the multiplication and obtain a result equal to zero for that entry of the coded matrix).

In some examples, each UE 115 may (e.g., locally) compute (e.g., calculate, obtain, determine) a respective coded matrix (e.g., Qⱼ), for example, in accordance with Equation 3 (e.g., where j corresponds to a respective UE 115).

$${Q}_{j} = {\sum }_{i = 0}^{k - 1} {c}_{i}^{j} {A}_{i} \qquad ( 3 )$$

For example, the UE 115-a may compute a coded matrix, Q₀, based

$${Q}_{0} = {\sum }_{i = 0}^{k - 1} {c}_{i}^{0} {A}_{i} ,$$

and the UE 115-b may compute a coded matrix, Q₁, based on

$${Q}_{1} = {\sum }_{i = 0}^{k - 1} {c}_{i}^{1} {A}_{i} ,$$

and so on.

Each UE 115 may multiply the computed coded matrix by the vector 215 to obtain a respective result vector 225 (e.g., zⱼ), for example, in accordance with Equation 4.

$${z}_{j} = {Q}_{j} \cdot b \qquad ( 4 )$$

Accordingly, the UEs 115 may respectively transmit the result vectors 225 (e.g., the multiplication result) to the network entity 105-a (e.g., via the respective links 125). For example, the UE 115-a may transmit the result, z₀, the UE 115-b may transmit the result, z₁, the UE 115-c may transmit the result, zⱼ, and the UE 115-d may transmit the result, zₙ₋₁.

In some examples, when the network entity 105-a receives a threshold quantity of result vectors 225 (e.g., after enough replies are received), the network entity 105-a may obtain the computation result vector 220 (e.g., x) using the received result vectors 225 (e.g., and/or combinations thereof). For example, the network entity 105-a may obtain the computation result vector 220 in accordance with Equation 2. In some examples, the network entity 105-a may not receive a reply from one or more of the UEs 115. For example, the UE 115-c may experience poor channel condition or may not support sufficient processing capability to perform the computation. Thus, the UE 115-c may fail to transmit the result, zⱼ. However, the network entity 105-a may be able to obtain the missing result, zⱼ, from a combination of one or more other received results (e.g., z₀, z₁, zₙ₋₁, some other result, or any combination thereof).

In some examples, the network entity 105-a may indicate a mapping of resources used to communicate various portions of the signaling 230. For example, the network entity 105-a may transmit an indication (e.g., via DCI signaling, MAC-CE signaling, RRC signaling, or some other mechanism) of a mapping of each sub-matrix 212 to one or more physical resources (e.g., time resources, frequency resources, layer resources) to the UEs 115. In some examples, the UEs 115 may each UE 115 may receive (e.g., decode) the relevant sub-matrices 212 based on receiving the mapping information (e.g., and based on the received coding coefficients 235). As an illustrative example, the UE 115-b may receive mapping information that associates (e.g., maps) each sub-matrix 212 with a respective set of resources. The UE 115-b may also receive coding coefficients, c¹, where

$${c}^{1} = [ 1 , 0 , 01 ] ( e . g . , {c}_{0}^{1} = {c}_{3}^{1} = 1 and {c}_{1}^{1} = {c}_{2}^{1} = 0 ) .$$

Accordingly, if the network entity 105-a broadcasts the set, {A₀, A₁, A₂, A₃}, the UE 115-b may receive sub-matrices A₀ and A₃ according to their corresponding sets of resources indicated by the mapping information, and the UE 115-b may not receive sub-matrices A₁ and A₂.

In some examples, a UE 115 may identify one or more resources (e.g., physical resources) for transmitting a result vector 225 (e.g., a feedback message). For example, the network entity 105-a may indicate the resources (e.g., explicitly) to each UE 115 (e.g., per UE 115). Additionally, or alternatively, a UE 115 may derive the resources (e.g., implicitly) based on a downlink allocation of the sub-matrix 212 (e.g., and/or one or more coding rows in the encoding matrix) corresponding to the UE 115. For example, a UE 115 may receive a sub-matrix 212 in accordance with a given set of downlink resources. Based on the given downlink resources for the sub-matrix 212, the UE 115 may be configured to derive a set of uplink resources to transmit the corresponding result vector 225. In another example, each row (e.g., or column) in the coding matrix may be mapped to one or more physical resources (e.g., time, frequency, and layer). Accordingly, in response to receiving a MAC-CE or DCI indicating the row of the coding matrix, the UE 115 may have an indication of the resources to use for transmitting the result vector 225. In some examples, one or more rules for an implicit resource mapping may be conveyed via RRC message.

A UE 115 may participate in distributed coding and computation operations based on a capability of the UE 115. For example, each UE 115 capable of participating in the CDC may indicate (e.g., publish, convey, communicate) its capability (e.g., a computational processing capability of the UE 115, a storage capability of the UE 115, or some other capability) to the network entity 105-a. In some examples, a capability indication may be a binary indication (e.g., yes or no) or may be associated with one or more grade levels (e.g., a first grade level indicating a first capability, a second grade level indicating a second capability different than the first capability, and so on). Accordingly, the network entity 105-a may allocate a computation portion (e.g., different quantities of rows in the matrix A) based on the indicated capability of each UE 115 (e.g., a quantity of rows allocated per UE 115 may be proportional to the capability grade of the UE 115).

In some examples, one or more techniques herein may support a physical layer capable of performing such operations with respect to AI/ML applications (e.g., based on improved computational ability with reduced signaling overhead). That is, the implementation of coded distributed edge computation in the wireless communications system 200 may support signaling mechanisms (e.g., at a physical layer) for AI/ML-based implementations. For example, by broadcasting information (e.g., via broadcast signaling 230) to multiple UEs 115 (e.g., multiple edges) may improve efficiency in distributed computation operations. As each of the UE 115 locally encodes a same matrix (e.g., A), the physical layer may support the network entity 105-a by broadcasting the same matrix (e.g., or portions thereof) to all UEs 115 over a same set of resources (e.g., time and frequency resources). Moreover, as an encoding operation may not utilize (e.g., does not require) all the sub-matrices 212, further alterations of the physical layer may be applied (e.g., by indicating the UEs 115 with the transmission scheduling resources of the sub-matrices 212), which may allow each UE 115 to decode a subset of the sub-matrices (e.g., and thus reduce processing power).

Thus, by applying one or more techniques herein, the wireless communications system 200 may support improved edge computation capabilities (e.g., improved reliability using CDC) with reduced impact to computational complexity at a single device (e.g., at a network entity 105-a). For example, by distributing the burden of the encoding operation across multiple devices, the wireless communications system 200 may perform relatively complex operations (e.g., associated with data intensive applications). Additionally, utilizing the broadcast signaling 230 may reduce signaling traffic in the wireless communications system 200. As such, the wireless communications system 200 may be associated with reduced latency, increased data rates, increased spectral efficiency, and improved user experience, among other benefits.

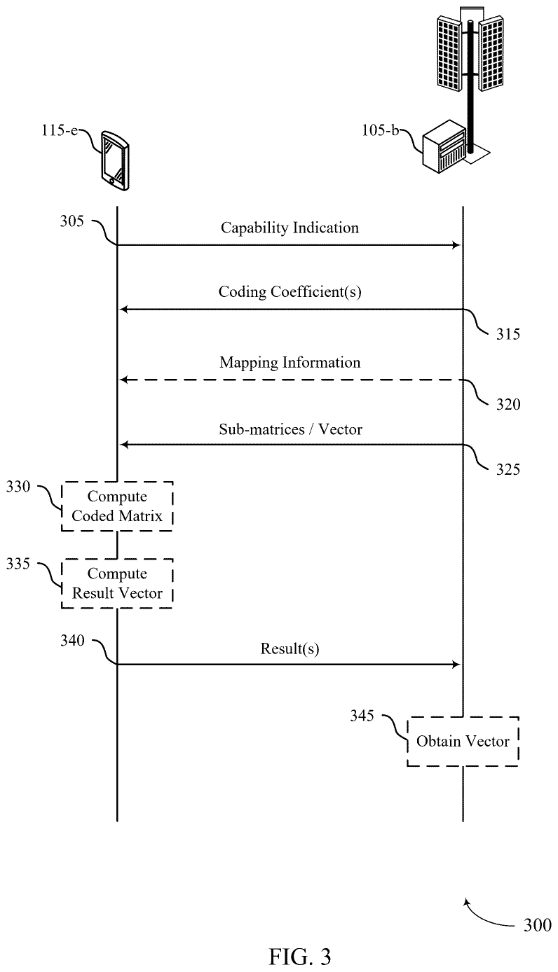

FIG. 3 shows an example of a process flow 300 that supports edge computation with distributed coding in accordance with one or more aspects of the present disclosure. In some examples, the process flow 300 may implement aspects of the wireless communications system 100 and the wireless communications system 200 as described herein. For example, the process flow 300 may support signaling between a UE 115-e and a network entity 105-a, which may be examples of corresponding devices described herein, including with reference to FIGS. 1 and 2. In the following description of the process flow 300, the operations between the UE 115-e and the network entity 105-b may be performed in a different order than the order shown, or other operations may be added or removed from the process flow 300. For example, some operations may also be left out of the process flow 300, or may be performed in different orders or at different times. Further, although some operations or signaling may be shown to occur at different times for discussion purposes, these operations may actually occur at the same time. Although the UE 115-e and the network entity 105-b are shown performing the operations of the process flow 300, some aspects of some operations may also be performed by one or more other wireless or network devices.

At 305, the UE 115-e may transmit a capability message indicative of whether the UE 115-e is capable of performing a CDC operation, which may be obtained (e.g., received) by the network entity 105-b. In some examples, the capability message may include a capability level of the UE 115-e. Moreover, the capability level may be based on a computational capability of the UE 115-e, a storage capability of the UE 115-e, some other capability of the UE 115-e, or any combination thereof.

At 315, the UE 115-e may receive information indicative of one or more coding coefficients (e.g., coding coefficients 235,

$${c}_{i}^{j} )$$

of set of multiple coding coefficients, which may be output (e.g., transmitted) by the network entity 105-b. In some examples, the coding coefficients may be associated with encoding a matrix (e.g., A). In some examples, receiving the information indicative of the one or more coding coefficients may be based on transmitting the capability message. In some examples, a quantity of the one or more coding coefficients may be based on the capability level indicated by the UE 115. In some examples, the information indicative of the one or more coding coefficients may include a vector (e.g., c), where each element (e.g.,

$${c}_{i}^{j} )$$

of the vector may be associated with a respective coding coefficient of the set of multiple coding coefficients. In some examples, a value of each element (e.g., a non-zero value or a zero value) of the vector may indicate whether a corresponding coding coefficient is included in the one or more coding coefficients applicable to the UE 115-e (e.g., or whether a corresponding sub-matrix is applicable to a computation performed by the UE 115-e, or both).

In some examples, the information indicative of the one or more coding coefficients may be received via a MAC-CE message, a DCI message, an RRC message, some other signaling, or any combination thereof. In some examples, the UE 115-e may be configured to obtain (e.g., from storage, based on a pre-defined matrix) a coding matrix including the set of multiple coding coefficients. The UE 115-e may also receive an indication of one or more rows of the coding matrix that include the one or more coding coefficients applicable to the UE 115-e. Additionally, or alternatively, the UE 115-e may obtain the coding matrix via an RRC message. In such examples, the indication of the one or more rows may be received via a MAC-CE message, a DCI message, or both.

At 320, in some examples, the UE 115-e may receive an indication of a mapping between each sub-matrix (e.g., each sub-matrix 212) of a set of sub-matrices (e.g., associated with a same encoding operation and/or distributed computing operation) and one or more respective physical resources, which may be output by the network entity 105-b. In some examples, each set of respective physical resources may include a set of time resources, a set of frequency resources, a set of spatial resources, or any combination thereof. Additionally, or alternatively, the UE 115-e may receive an indication of a set of resources for transmitting a result vector (e.g., a result vector 225, zⱼ) to the network entity 105-b. Additionally, or alternatively, the UE 115-e may receive (e.g., via control signaling) an indication of a mapping between a set of resources and a downlink resource allocation, and the set of resources for receiving the sub-matrices and/or transmitting the result vector may be derived in accordance with the mapping.

At 325, the UE 115-e may receive, via broadcast signaling (e.g., broadcast signaling 230), one or more sub-matrices {A₀, A₁, . . . , Aₖ₋₁} of a matrix (e.g., A) and a vector (e.g., b), which may be output by the network entity 105-b. In some examples, each sub-matrix of the one or more sub-matrices may be received via a respective physical resource (e.g., indicated via mapping information). In some examples, the one or more sub-matrices of the matrix may be identified according to the one or more coding coefficients. That is, the UE 115-e may be configured to determine which sub-matrix or sub-matrices are applicable to the UE 115-e.

In some examples, the broadcast signaling may include multiple sub-matrices of a matrix, and the multiple sub-matrices may include one or more sub-matrices applicable to the UE 115-e and one or more other sub-matrices applicable to one or more other UEs 115 (not shown). That is, the UE 115-e may receive (e.g., detect, based on the broadcast signaling) one or more sub-matrices that are not encoded by the UE 115-e (e.g., are not used for computation at the UE 115-e). In some examples, receiving the one or more sub-matrices may be in accordance with the mapping information (e.g., received at 320).

At 330, in some examples, the UE 115-e may compute a coded matrix (e.g., Qⱼ) based on a multiply-and-accumulate operation of the one or more coding coefficients and the one or more sub-matrices (e.g., based on Equation 3). At 335, in some examples, the UE 115-e may compute the result vector based on multiplying a result of the multiply-and-accumulate operation with the vector (e.g., based on Equation 4).

At 340, the UE 115-e may transmit a result vector in accordance with receiving the one or more sub-matrices, which may be obtained (e.g., received) by the network entity 105-b. In some examples, the result vector may be obtained (e.g., computed, calculated, determined) according to a multiplication of a coded matrix and the vector, and the coded matrix may be obtained according to a combination of the one or more coding coefficients and the one or more sub-matrices. In some examples, the UE 115-e may transmit the result vector via a set of resources that are derived according to a downlink resource allocation of the one or more sub-matrices (e.g., based on resources used to communicate the sub-matrix or sub-matrices), according to the one or more coding coefficients (e.g., based on which coefficients are applicable to the UE 115-e, or both.

At 345, the network entity 105-b may obtain a vector (e.g., a computation result vector 220, x, a computation result) using one or more respective result vector obtained from one or more UEs 115 (e.g., including the UE 115-e) and a decoding matrix (e.g., Dⱼ). In some examples, obtaining the vector may be performed in accordance with (e.g., based on) a quantity of obtained result matrices satisfying a threshold (e.g., after a given quantity of responses are received from one or more UEs 115).

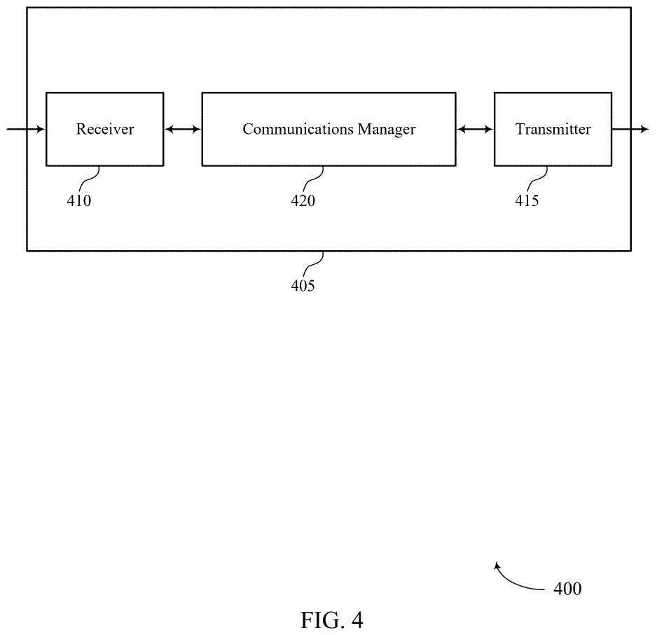

FIG. 4 shows a block diagram 400 of a device 405 that supports edge computation with distributed coding in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor (not shown), which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to edge computation with distributed coding). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to edge computation with distributed coding). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of edge computation with distributed coding as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving information indicative of one or more coding coefficients of a set of multiple coding coefficients, where the set of multiple coding coefficients are associated with encoding a first matrix. The communications manager 420 is capable of, configured to, or operable to support a means for receiving, via broadcast signaling, one or more sub-matrices of the first matrix and a vector, where each sub-matrix of the one or more sub-matrices is received via a respective physical resource, and where the one or more sub-matrices of the first matrix are identified according to the one or more coding coefficients. The communications manager 420 is capable of, configured to, or operable to support a means for transmitting a result vector in accordance with receiving the one or more sub-matrices, where the result vector is obtained according to a multiplication of a coded matrix and the vector, and where the coded matrix is obtained according to a combination of the one or more coding coefficients and the one or more sub-matrices.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources and increased support for data intensive applications, among other benefits.

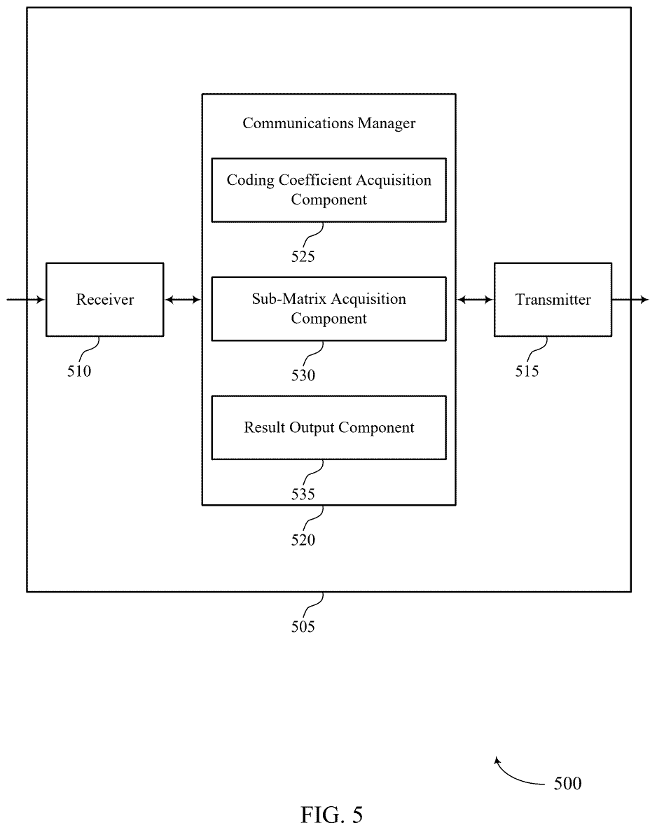

FIG. 5 shows a block diagram 500 of a device 505 that supports edge computation with distributed coding in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor (not shown), which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to edge computation with distributed coding). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to edge computation with distributed coding). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of edge computation with distributed coding as described herein. For example, the communications manager 520 may include a coding coefficient acquisition component 525, a sub-matrix acquisition component 530, a result output component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The coding coefficient acquisition component 525 is capable of, configured to, or operable to support a means for receiving information indicative of one or more coding coefficients of a set of multiple coding coefficients, where the set of multiple coding coefficients are associated with encoding a first matrix. The sub-matrix acquisition component 530 is capable of, configured to, or operable to support a means for receiving, via broadcast signaling, one or more sub-matrices of the first matrix and a vector, where each sub-matrix of the one or more sub-matrices is received via a respective physical resource, and where the one or more sub-matrices of the first matrix are identified according to the one or more coding coefficients. The result output component 535 is capable of, configured to, or operable to support a means for transmitting a result vector in accordance with receiving the one or more sub-matrices, where the result vector is obtained according to a multiplication of a coded matrix and the vector, and where the coded matrix is obtained according to a combination of the one or more coding coefficients and the one or more sub-matrices.

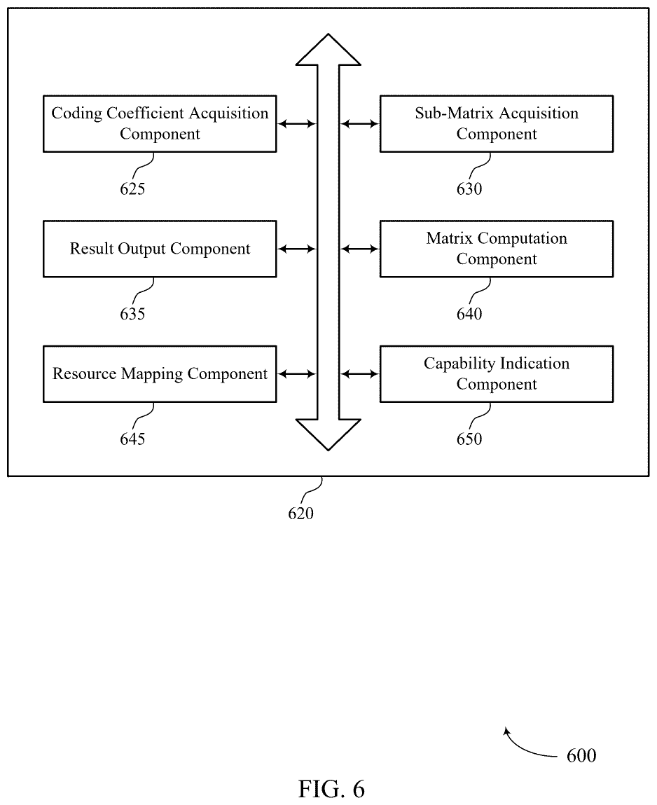

FIG. 6 shows a block diagram 600 of a communications manager 620 that supports edge computation with distributed coding in accordance with one or more aspects of the present disclosure. The communications manager 620 may be an example of aspects of a communications manager 420, a communications manager 520, or both, as described herein. The communications manager 620, or various components thereof, may be an example of means for performing various aspects of edge computation with distributed coding as described herein. For example, the communications manager 620 may include a coding coefficient acquisition component 625, a sub-matrix acquisition component 630, a result output component 635, a matrix computation component 640, a resource mapping component 645, a capability indication component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The coding coefficient acquisition component 625 is capable of, configured to, or operable to support a means for receiving information indicative of one or more coding coefficients of a set of multiple coding coefficients, where the set of multiple coding coefficients are associated with encoding a first matrix. The sub-matrix acquisition component 630 is capable of, configured to, or operable to support a means for receiving, via broadcast signaling, one or more sub-matrices of the first matrix and a vector, where each sub-matrix of the one or more sub-matrices is received via a respective physical resource, and where the one or more sub-matrices of the first matrix are identified according to the one or more coding coefficients. The result output component 635 is capable of, configured to, or operable to support a means for transmitting a result vector in accordance with receiving the one or more sub-matrices, where the result vector is obtained according to a multiplication of a coded matrix and the vector, and where the coded matrix is obtained according to a combination of the one or more coding coefficients and the one or more sub-matrices.

In some examples, the broadcast signaling includes a set of multiple sub-matrices that include the first matrix. In some examples, the set of multiple sub-matrices include the one or more sub-matrices for the UE and one or more other sub-matrices applicable to one or more other UEs.

In some examples, the information indicative of the one or more coding coefficients includes a second vector. In some examples, each element of the second vector is associated with a respective coding coefficient of the set of multiple coding coefficients. In some examples, a value of each element of the second vector indicates whether a corresponding coding coefficient is included in the one or more coding coefficients.

In some examples, the matrix computation component 640 is capable of, configured to, or operable to support a means for computing the coded matrix based on a multiply-and-accumulate operation of the one or more coding coefficients and the one or more sub-matrices. In some examples, the matrix computation component 640 is capable of, configured to, or operable to support a means for computing the result vector based on multiplying a result of the multiply-and-accumulate operation with the vector.

In some examples, the information indicative of the one or more coding coefficients is received via a MAC-CE message, a DCI message, an RRC message, or any combination thereof.

In some examples, to support receiving the information indicative of the one or more coding coefficients, the coding coefficient acquisition component 625 is capable of, configured to, or operable to support a means for obtaining a coding matrix including the set of multiple coding coefficients. In some examples, to support receiving the information indicative of the one or more coding coefficients, the coding coefficient acquisition component 625 is capable of, configured to, or operable to support a means for receiving an indication of one or more rows of the coding matrix that includes the one or more coding coefficients.

In some examples, the coding matrix is obtained via an RRC message. In some examples, the indication of the one or more rows is received via a MAC-CE message, a DCI message, or both.

In some examples, the resource mapping component 645 is capable of, configured to, or operable to support a means for receiving an indication of a mapping between each sub-matrix of the one or more sub-matrices and each respective physical resource, where each respective physical resource includes a set of time resources, a set of frequency resources, a set of spatial resources, or any combination thereof, and where receiving the one or more sub-matrices is in accordance with the mapping.

In some examples, the resource mapping component 645 is capable of, configured to, or operable to support a means for receiving an indication of a set of resources for transmitting the result vector, where the result vector is transmitted via the set of resources.

In some examples, to support transmitting the result vector, the result output component 635 is capable of, configured to, or operable to support a means for transmitting the result vector via a set of resources that are derived according to a downlink resource allocation of the one or more sub-matrices, according to the one or more coding coefficients, or both.

In some examples, the resource mapping component 645 is capable of, configured to, or operable to support a means for receiving, via control signaling, an indication of a mapping between the set of resources and the downlink resource allocation, where the set of resources are derived in accordance with the mapping.

In some examples, the capability indication component 650 is capable of, configured to, or operable to support a means for transmitting a capability message indicative of whether the UE is capable of performing CDC operations, where receiving the information indicative of the one or more coding coefficients is based on transmitting the capability message.

In some examples, the capability message includes a capability level of the UE, the capability level based on a computational capability of the UE, a storage capability of the UE, or both. In some examples, a quantity of the one or more coding coefficients is based on the capability level.

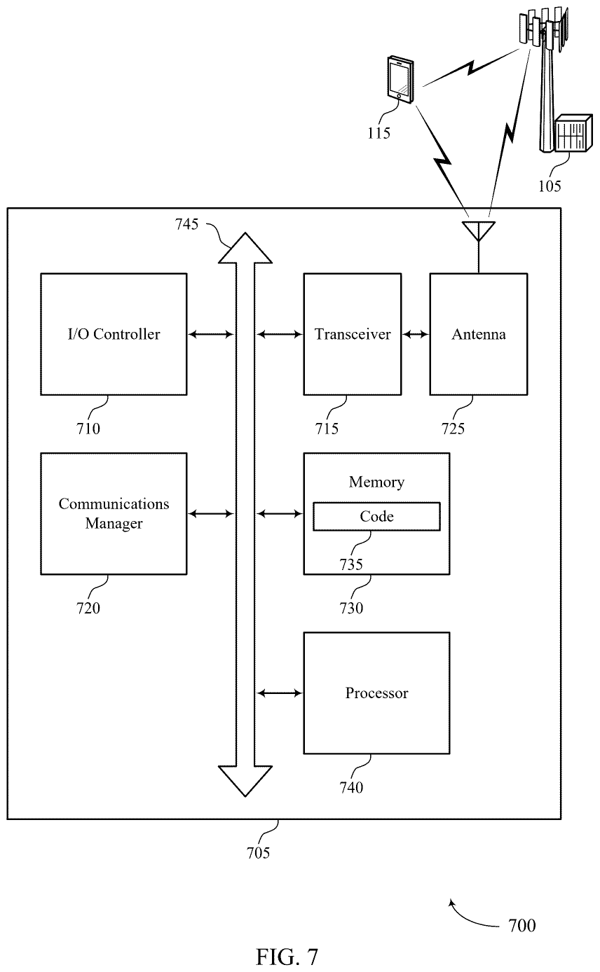

FIG. 7 shows a diagram of a system 700 including a device 705 that supports edge computation with distributed coding in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting edge computation with distributed coding). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving information indicative of one or more coding coefficients of a set of multiple coding coefficients, where the set of multiple coding coefficients are associated with encoding a first matrix. The communications manager 720 is capable of, configured to, or operable to support a means for receiving, via broadcast signaling, one or more sub-matrices of the first matrix and a vector, where each sub-matrix of the one or more sub-matrices is received via a respective physical resource, and where the one or more sub-matrices of the first matrix are identified according to the one or more coding coefficients. The communications manager 720 is capable of, configured to, or operable to support a means for transmitting a result vector in accordance with receiving the one or more sub-matrices, where the result vector is obtained according to a multiplication of a coded matrix and the vector, and where the coded matrix is obtained according to a combination of the one or more coding coefficients and the one or more sub-matrices.

By including or configuring the communications manager 720 in accordance with examples as described herein, the device 705 may support techniques for reduced latency, improved user experience related to reduced processing, more efficient utilization of communication resources, improved coordination between devices, and improved utilization of processing capability, among other benefits.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of edge computation with distributed coding as described herein, or the at least one processor 740 and the at least one memory 730 may be otherwise configured to, individually or collectively, perform or support such operations.

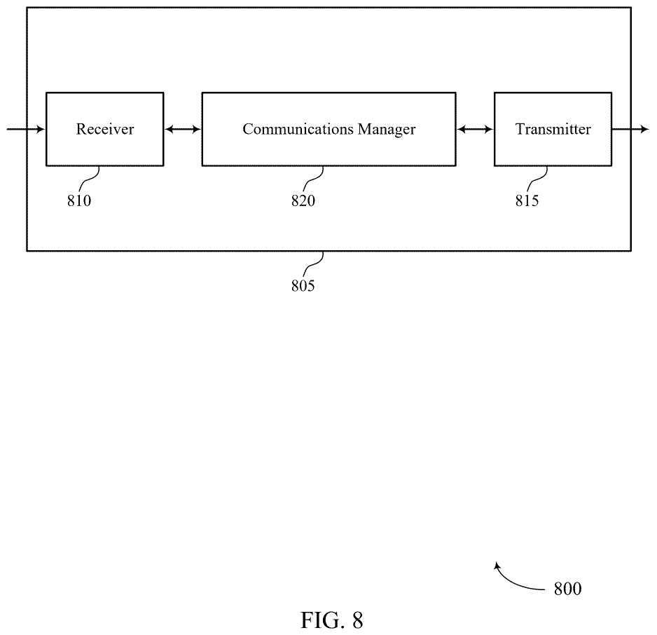

FIG. 8 shows a block diagram 800 of a device 805 that supports edge computation with distributed coding in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor (not shown), which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of edge computation with distributed coding as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting, to each UE of a set of multiple UEs, information indicative of one or more respective coding coefficients of a set of multiple coding coefficients, where the set of multiple coding coefficients are associated with encoding a first matrix. The communications manager 820 is capable of, configured to, or operable to support a means for outputting, via broadcast signaling, a set of multiple sub-matrices that include the first matrix and a vector, where each sub-matrix of the set of multiple sub-matrices is output via a respective physical resource. The communications manager 820 is capable of, configured to, or operable to support a means for obtaining, from one or more UEs of the set of multiple UEs, a respective result vector in accordance with outputting the set of multiple sub-matrices, where each respective result vector includes a multiplication of a coded matrix and the vector, and where each coded matrix is associated with a combination of the one or more respective coding coefficients and one or more sub-matrices.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources, among other benefits.

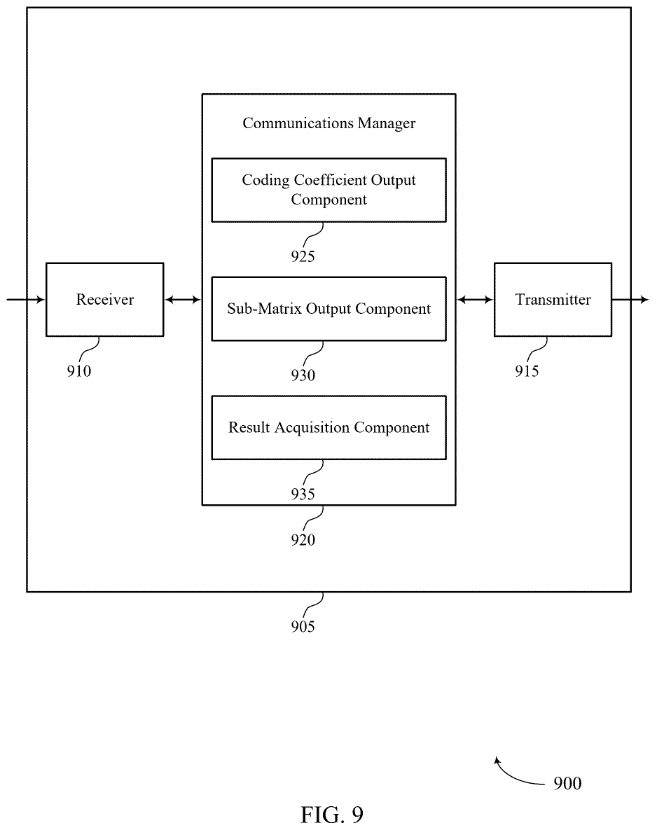

FIG. 9 shows a block diagram 900 of a device 905 that supports edge computation with distributed coding in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor (not shown), which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of edge computation with distributed coding as described herein. For example, the communications manager 920 may include a coding coefficient output component 925, a sub-matrix output component 930, a result acquisition component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The coding coefficient output component 925 is capable of, configured to, or operable to support a means for outputting, to each UE of a set of multiple UEs, information indicative of one or more respective coding coefficients of a set of multiple coding coefficients, where the set of multiple coding coefficients are associated with encoding a first matrix. The sub-matrix output component 930 is capable of, configured to, or operable to support a means for outputting, via broadcast signaling, a set of multiple sub-matrices that include the first matrix and a vector, where each sub-matrix of the set of multiple sub-matrices is output via a respective physical resource. The result acquisition component 935 is capable of, configured to, or operable to support a means for obtaining, from one or more UEs of the set of multiple UEs, a respective result vector in accordance with outputting the set of multiple sub-matrices, where each respective result vector includes a multiplication of a coded matrix and the vector, and where each coded matrix is associated with a combination of the one or more respective coding coefficients and one or more sub-matrices.

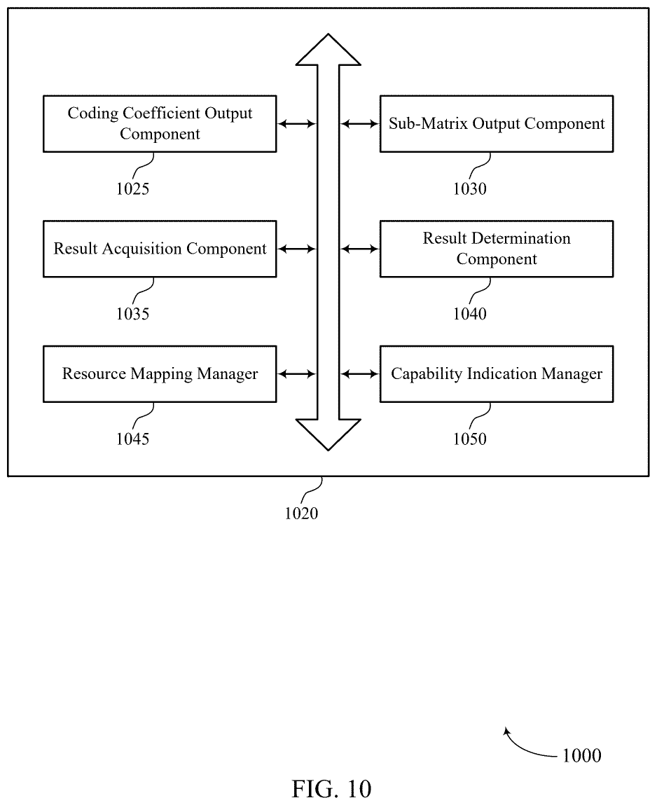

FIG. 10 shows a block diagram 1000 of a communications manager 1020 that supports edge computation with distributed coding in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of edge computation with distributed coding as described herein. For example, the communications manager 1020 may include a coding coefficient output component 1025, a sub-matrix output component 1030, a result acquisition component 1035, a result determination component 1040, a resource mapping manager 1045, a capability indication manager 1050, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The coding coefficient output component 1025 is capable of, configured to, or operable to support a means for outputting, to each UE of a set of multiple UEs, information indicative of one or more respective coding coefficients of a set of multiple coding coefficients, where the set of multiple coding coefficients are associated with encoding a first matrix. The sub-matrix output component 1030 is capable of, configured to, or operable to support a means for outputting, via broadcast signaling, a set of multiple sub-matrices that include the first matrix and a vector, where each sub-matrix of the set of multiple sub-matrices is output via a respective physical resource. The result acquisition component 1035 is capable of, configured to, or operable to support a means for obtaining, from one or more UEs of the set of multiple UEs, a respective result vector in accordance with outputting the set of multiple sub-matrices, where each respective result vector includes a multiplication of a coded matrix and the vector, and where each coded matrix is associated with a combination of the one or more respective coding coefficients and one or more sub-matrices.

In some examples, the result determination component 1040 is capable of, configured to, or operable to support a means for obtaining a computation result vector using each respective result vector obtained from the one or more UEs and a decoding matrix, where obtaining the computation result vector is in accordance with a quantity of obtained result matrices satisfying a threshold.

In some examples, the information indicative of the one or more respective coding coefficients includes a second vector. In some examples, each element of the second vector is associated with a respective coding coefficient of the set of multiple coding coefficients. In some examples, a value of each element of the second vector indicates whether a corresponding coding coefficient is associated with a UE of the set of multiple UEs.

In some examples, the information indicative of the one or more respective coding coefficients is output via a MAC-CE message, a DCI message, an RRC message, or any combination thereof.

In some examples, to support outputting the information indicative of the one or more respective coding coefficients, the coding coefficient output component 1025 is capable of, configured to, or operable to support a means for outputting a coding matrix including the set of multiple coding coefficients. In some examples, to support outputting the information indicative of the one or more respective coding coefficients, the coding coefficient output component 1025 is capable of, configured to, or operable to support a means for outputting an indication of one or more rows of the coding matrix that includes the one or more respective coding coefficients.

In some examples, the coding matrix is output via an RRC message. In some examples, the indication of the one or more rows is output via a MAC-CE message, a DCI message, or both.

In some examples, the resource mapping manager 1045 is capable of, configured to, or operable to support a means for outputting an indication of a mapping between each sub-matrix of the set of multiple sub-matrices and each respective physical resource, where each respective physical resource includes a set of time resources, a set of frequency resources, a set of spatial resources, or any combination thereof, and where outputting the set of multiple sub-matrices is in accordance with the mapping.

In some examples, the resource mapping manager 1045 is capable of, configured to, or operable to support a means for outputting an indication of a set of multiple sets of resources for each respective result vector, where the respective result vector is obtained via a set of resources of the set of multiple sets of resources.

In some examples, to support obtaining the respective result vector from the one or more UEs, the result acquisition component 1035 is capable of, configured to, or operable to support a means for obtaining, from a first UE of the set of multiple UEs, a first result vector via a first set of resources that are according to a first downlink resource allocation of one or more first sub-matrices associated with the first UE, according to one or more first respective coding coefficients associated with the first UE, or both.

In some examples, the resource mapping manager 1045 is capable of, configured to, or operable to support a means for outputting, via control signaling and to the first UE, an indication of a mapping between the first set of resources and the first downlink resource allocation.

In some examples, the capability indication manager 1050 is capable of, configured to, or operable to support a means for obtaining, from each UE of the set of multiple UEs, a capability message indicative of whether each UE is capable of performing CDC operations, where outputting the information indicative of the one or more respective coding coefficients is based on obtaining the capability message.

In some examples, the capability message includes a capability level of each UE of the set of multiple UEs, the capability level based on a computational capability of each UE, a storage capability of each UE, or both. In some examples, a quantity of the one or more respective coding coefficients is based on the capability level.

In some examples, a quantity of the set of multiple UEs is greater than a quantity of the set of multiple sub-matrices of the first matrix.

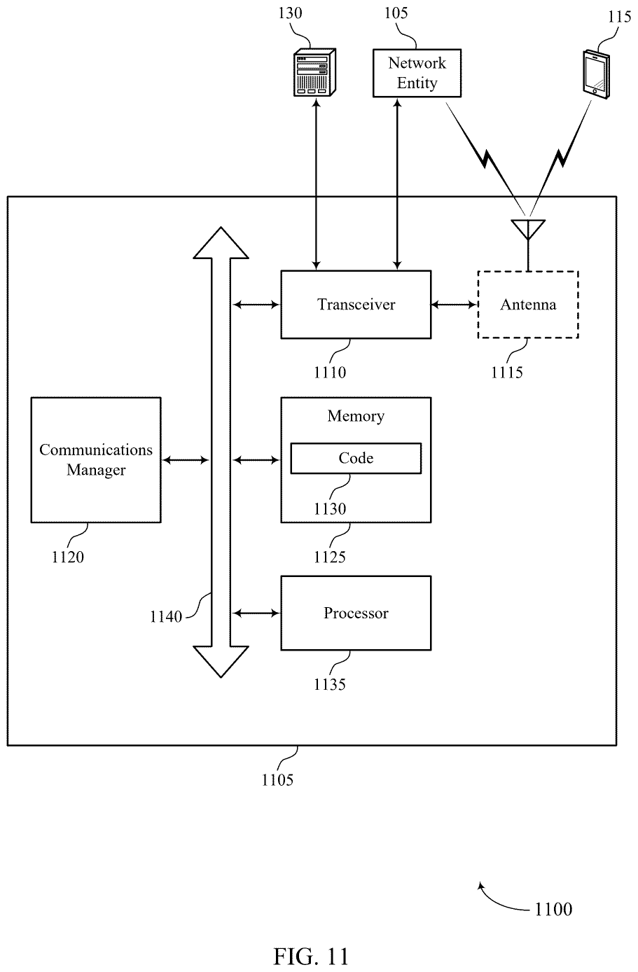

FIG. 11 shows a diagram of a system 1100 including a device 1105 that supports edge computation with distributed coding in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting edge computation with distributed coding). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting, to each UE of a set of multiple UEs, information indicative of one or more respective coding coefficients of a set of multiple coding coefficients, where the set of multiple coding coefficients are associated with encoding a first matrix. The communications manager 1120 is capable of, configured to, or operable to support a means for outputting, via broadcast signaling, a set of multiple sub-matrices that include the first matrix and a vector, where each sub-matrix of the set of multiple sub-matrices is output via a respective physical resource. The communications manager 1120 is capable of, configured to, or operable to support a means for obtaining, from one or more UEs of the set of multiple UEs, a respective result vector in accordance with outputting the set of multiple sub-matrices, where each respective result vector includes a multiplication of a coded matrix and the vector, and where each coded matrix is associated with a combination of the one or more respective coding coefficients and one or more sub-matrices.

By including or configuring the communications manager 1120 in accordance with examples as described herein, the device 1105 may support techniques for reduced latency, improved user experience related to reduced processing, reduced power consumption, more efficient utilization of communication resources, improved coordination between devices, longer battery life, and improved utilization of processing capability, among other benefits.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of edge computation with distributed coding as described herein, or the at least one processor 1135 and the at least one memory 1125 may be otherwise configured to, individually or collectively, perform or support such operations.

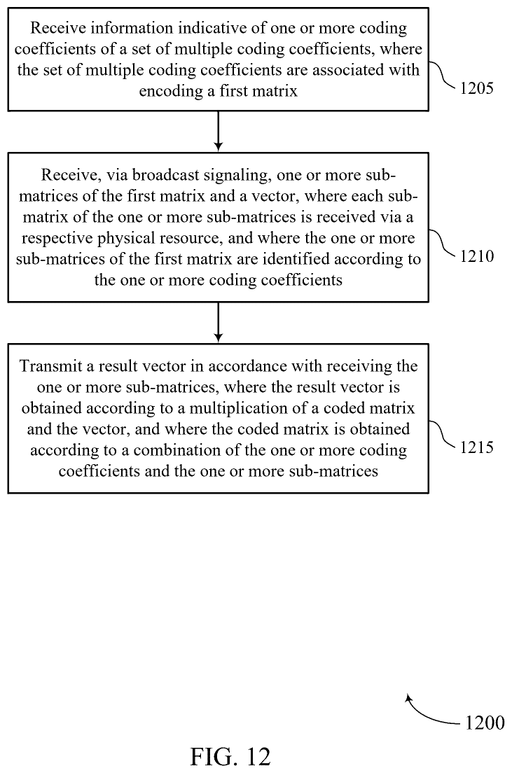

FIG. 12 shows a flowchart illustrating a method 1200 that supports edge computation with distributed coding in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving information indicative of one or more coding coefficients of a set of multiple coding coefficients, where the set of multiple coding coefficients are associated with encoding a first matrix. The operations of 1205 may be performed in accordance with examples as disclosed herein. In some examples, aspects of the operations of 1205 may be performed by a coding coefficient acquisition component 625 as described with reference to FIG. 6.

At 1210, the method may include receiving, via broadcast signaling, one or more sub-matrices of the first matrix and a vector, where each sub-matrix of the one or more sub-matrices is received via a respective physical resource, and where the one or more sub-matrices of the first matrix are identified according to the one or more coding coefficients. The operations of 1210 may be performed in accordance with examples as disclosed herein. In some examples, aspects of the operations of 1210 may be performed by a sub-matrix acquisition component 630 as described with reference to FIG. 6.

At 1215, the method may include transmitting a result vector in accordance with receiving the one or more sub-matrices, where the result vector is obtained according to a multiplication of a coded matrix and the vector, and where the coded matrix is obtained according to a combination of the one or more coding coefficients and the one or more sub-matrices. The operations of 1215 may be performed in accordance with examples as disclosed herein. In some examples, aspects of the operations of 1215 may be performed by a result output component 635 as described with reference to FIG. 6.

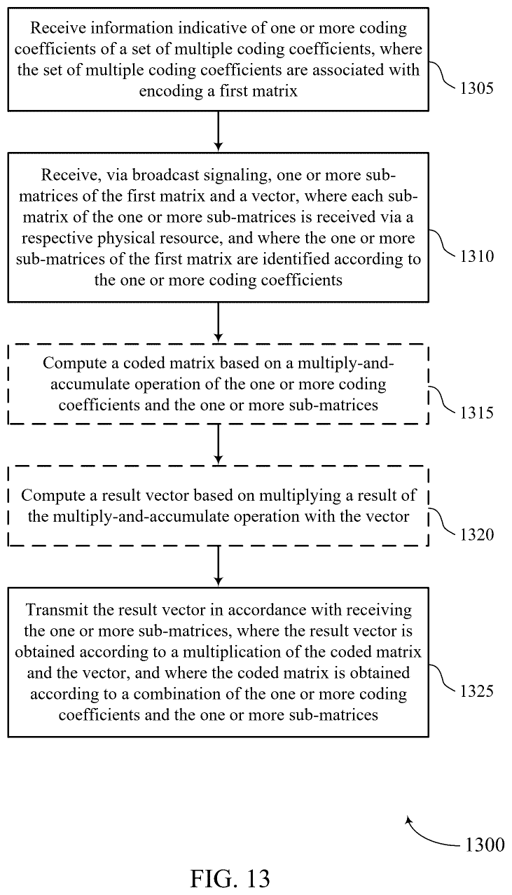

FIG. 13 shows a flowchart illustrating a method 1300 that supports edge computation with distributed coding in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving information indicative of one or more coding coefficients of a set of multiple coding coefficients, where the set of multiple coding coefficients are associated with encoding a first matrix. The operations of 1305 may be performed in accordance with examples as disclosed herein. In some examples, aspects of the operations of 1305 may be performed by a coding coefficient acquisition component 625 as described with reference to FIG. 6.

At 1310, the method may include receiving, via broadcast signaling, one or more sub-matrices of the first matrix and a vector, where each sub-matrix of the one or more sub-matrices is received via a respective physical resource, and where the one or more sub-matrices of the first matrix are identified according to the one or more coding coefficients. The operations of 1310 may be performed in accordance with examples as disclosed herein. In some examples, aspects of the operations of 1310 may be performed by a sub-matrix acquisition component 630 as described with reference to FIG. 6.

At 1315, in some examples, the method may include computing a coded matrix based on a multiply-and-accumulate operation of the one or more coding coefficients and the one or more sub-matrices. The operations of 1315 may be performed in accordance with examples as disclosed herein. In some examples, aspects of the operations of 1315 may be performed by a matrix computation component 640 as described with reference to FIG. 6.

At 1320, in some examples, the method may include computing a result vector based on multiplying a result of the multiply-and-accumulate operation with the vector. The operations of 1320 may be performed in accordance with examples as disclosed herein. In some examples, aspects of the operations of 1320 may be performed by a matrix computation component 640 as described with reference to FIG. 6.

At 1325, the method may include transmitting the result vector in accordance with receiving the one or more sub-matrices, where the result vector is obtained according to a multiplication of the coded matrix and the vector, and where the coded matrix is obtained according to a combination of the one or more coding coefficients and the one or more sub-matrices. The operations of 1325 may be performed in accordance with examples as disclosed herein. In some examples, aspects of the operations of 1325 may be performed by a result output component 635 as described with reference to FIG. 6.

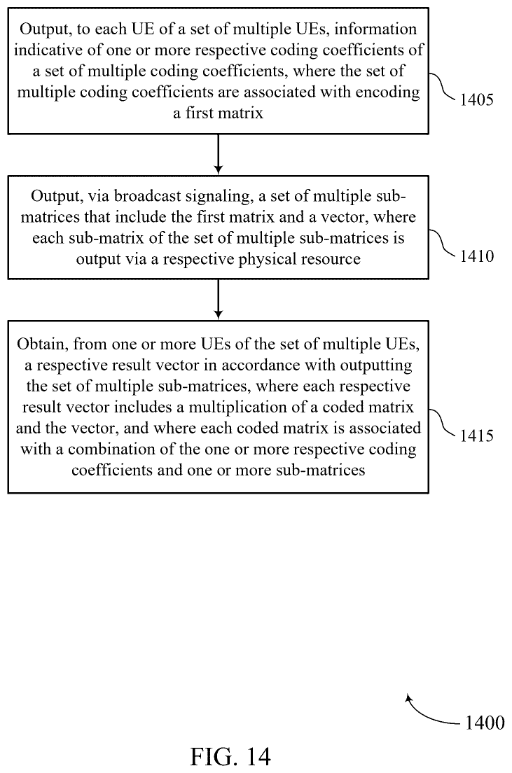

FIG. 14 shows a flowchart illustrating a method 1400 that supports edge computation with distributed coding in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include outputting, to each UE of a set of multiple UEs, information indicative of one or more respective coding coefficients of a set of multiple coding coefficients, where the set of multiple coding coefficients are associated with encoding a first matrix. The operations of 1405 may be performed in accordance with examples as disclosed herein. In some examples, aspects of the operations of 1405 may be performed by a coding coefficient output component 1025 as described with reference to FIG. 10.

At 1410, the method may include outputting, via broadcast signaling, a set of multiple sub-matrices that include the first matrix and a vector, where each sub-matrix of the set of multiple sub-matrices is output via a respective physical resource. The operations of 1410 may be performed in accordance with examples as disclosed herein. In some examples, aspects of the operations of 1410 may be performed by a sub-matrix output component 1030 as described with reference to FIG. 10.

At 1415, the method may include obtaining, from one or more UEs of the set of multiple UEs, a respective result vector in accordance with outputting the set of multiple sub-matrices, where each respective result vector includes a multiplication of a coded matrix and the vector, and where each coded matrix is associated with a combination of the one or more respective coding coefficients and one or more sub-matrices. The operations of 1415 may be performed in accordance with examples as disclosed herein. In some examples, aspects of the operations of 1415 may be performed by a result acquisition component 1035 as described with reference to FIG. 10.

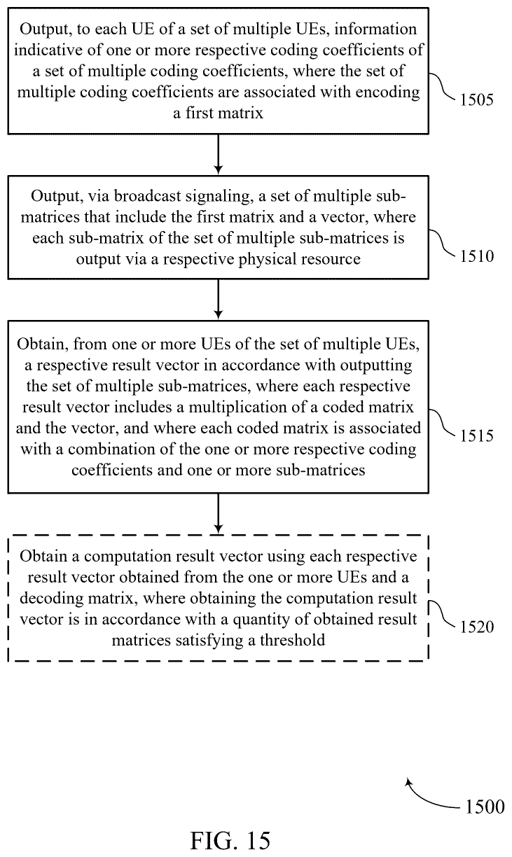

FIG. 15 shows a flowchart illustrating a method 1500 that supports edge computation with distributed coding in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting, to each UE of a set of multiple UEs, information indicative of one or more respective coding coefficients of a set of multiple coding coefficients, where the set of multiple coding coefficients are associated with encoding a first matrix. The operations of 1505 may be performed in accordance with examples as disclosed herein. In some examples, aspects of the operations of 1505 may be performed by a coding coefficient output component 1025 as described with reference to FIG. 10.

At 1510, the method may include outputting, via broadcast signaling, a set of multiple sub-matrices that include the first matrix and a vector, where each sub-matrix of the set of multiple sub-matrices is output via a respective physical resource. The operations of 1510 may be performed in accordance with examples as disclosed herein. In some examples, aspects of the operations of 1510 may be performed by a sub-matrix output component 1030 as described with reference to FIG. 10.

At 1515, the method may include obtaining, from one or more UEs of the set of multiple UEs, a respective result vector in accordance with outputting the set of multiple sub-matrices, where each respective result vector includes a multiplication of a coded matrix and the vector, and where each coded matrix is associated with a combination of the one or more respective coding coefficients and one or more sub-matrices. The operations of 1515 may be performed in accordance with examples as disclosed herein. In some examples, aspects of the operations of 1515 may be performed by a result acquisition component 1035 as described with reference to FIG. 10.

At 1520, in some examples, the method may include obtaining a computation result vector using each respective result vector obtained from the one or more UEs and a decoding matrix, where obtaining the computation result vector is in accordance with a quantity of obtained result matrices satisfying a threshold. The operations of 1520 may be performed in accordance with examples as disclosed herein. In some examples, aspects of the operations of 1520 may be performed by a result determination component 1040 as described with reference to FIG. 10.

The following provides an overview of aspects of the present disclosure:
Aspect 1: A method for wireless communications at a UE, comprising: receiving information indicative of one or more coding coefficients of a plurality of coding coefficients, wherein the plurality of coding coefficients are associated with encoding a first matrix; receiving, via broadcast signaling, one or more sub-matrices of the first matrix and a vector, wherein each sub-matrix of the one or more sub-matrices is received via a respective physical resource, and wherein the one or more sub-matrices of the first matrix are identified according to the one or more coding coefficients; and transmitting a result vector in accordance with receiving the one or more sub-matrices, wherein the result vector is obtained according to a multiplication of a coded matrix and the vector, and wherein the coded matrix is obtained according to a combination of the one or more coding coefficients and the one or more sub-matrices.
Aspect 2: The method of aspect 1, wherein the broadcast signaling comprises a plurality of sub-matrices that comprise the first matrix, and the plurality of sub-matrices include the one or more sub-matrices for the UE and one or more other sub-matrices applicable to one or more other UEs.
Aspect 3: The method of any of aspects 1 through 2, wherein the information indicative of the one or more coding coefficients comprises a second vector, each element of the second vector is associated with a respective coding coefficient of the plurality of coding coefficients, and a value of each element of the second vector indicates whether a corresponding coding coefficient is included in the one or more coding coefficients.
Aspect 4: The method of any of aspects 1 through 3, further comprising: computing the coded matrix based at least in part on a multiply-and-accumulate operation of the one or more coding coefficients and the one or more sub-matrices; and computing the result vector based at least in part on multiplying a result of the multiply-and-accumulate operation with the vector.
Aspect 5: The method of any of aspects 1 through 4, wherein the information indicative of the one or more coding coefficients is received via a MAC-CE message, a DCI message, a RRC message, or any combination thereof.
Aspect 6: The method of any of aspects 1 through 5, wherein receiving the information indicative of the one or more coding coefficients comprises: obtaining a coding matrix comprising the plurality of coding coefficients; and receiving an indication of one or more rows of the coding matrix that comprises the one or more coding coefficients.
Aspect 7: The method of aspect 6, wherein the coding matrix is obtained via a RRC message, and the indication of the one or more rows is received via a MAC-CE message, a DCI message, or both.
Aspect 8: The method of any of aspects 1 through 7, further comprising: receiving an indication of a mapping between each sub-matrix of the one or more sub-matrices and each respective physical resource, wherein each respective physical resource comprises a set of time resources, a set of frequency resources, a set of spatial resources, or any combination thereof, and wherein receiving the one or more sub-matrices is in accordance with the mapping.
Aspect 9: The method of any of aspects 1 through 8, further comprising: receiving an indication of a set of resources for transmitting the result vector, wherein the result vector is transmitted via the set of resources.
Aspect 10: The method of any of aspects 1 through 9, wherein transmitting the result vector comprises: transmitting the result vector via a set of resources that are derived according to a downlink resource allocation of the one or more sub-matrices, according to the one or more coding coefficients, or both.
Aspect 11: The method of aspect 10, further comprising: receiving, via control signaling, an indication of a mapping between the set of resources and the downlink resource allocation, wherein the set of resources are derived in accordance with the mapping.
Aspect 12: The method of any of aspects 1 through 11, further comprising: transmitting a capability message indicative of whether the UE is capable of performing coded distributed computing operations, wherein receiving the information indicative of the one or more coding coefficients is based at least in part on transmitting the capability message.
Aspect 13: The method of aspect 12, wherein the capability message comprises a capability level of the UE, the capability level based at least in part on a computational capability of the UE, a storage capability of the UE, or both, and a quantity of the one or more coding coefficients is based at least in part on the capability level.
Aspect 14: A method for wireless communications at a network entity, comprising: outputting, to each UE of a plurality of UEs, information indicative of one or more respective coding coefficients of a plurality of coding coefficients, wherein the plurality of coding coefficients are associated with encoding a first matrix; outputting, via broadcast signaling, a plurality of sub-matrices that comprise the first matrix and a vector, wherein each sub-matrix of the plurality of sub-matrices is output via a respective physical resource; and obtaining, from one or more UEs of the plurality of UEs, a respective result vector in accordance with outputting the plurality of sub-matrices, wherein each respective result vector comprises a multiplication of a coded matrix and the vector, and wherein each coded matrix is associated with a combination of the one or more respective coding coefficients and one or more sub-matrices.
Aspect 15: The method of aspect 14, further comprising: obtaining a computation result vector using each respective result vector obtained from the one or more UEs and a decoding matrix, wherein obtaining the computation result vector is in accordance with a quantity of obtained result matrices satisfying a threshold.
Aspect 16: The method of any of aspects 14 through 15, wherein the information indicative of the one or more respective coding coefficients comprises a second vector, each element of the second vector is associated with a respective coding coefficient of the plurality of coding coefficients, and a value of each element of the second vector indicates whether a corresponding coding coefficient is associated with a UE of the plurality of UEs.
Aspect 17: The method of any of aspects 14 through 16, wherein the information indicative of the one or more respective coding coefficients is output via a MAC-CE message, a DCI message, a RRC message, or any combination thereof.
Aspect 18: The method of any of aspects 14 through 17, wherein outputting the information indicative of the one or more respective coding coefficients comprises: outputting a coding matrix comprising the plurality of coding coefficients; and outputting an indication of one or more rows of the coding matrix that comprises the one or more respective coding coefficients.
Aspect 19: The method of aspect 18, wherein the coding matrix is output via a RRC message, and the indication of the one or more rows is output via a MAC-CE message, a DCI message, or both.
Aspect 20: The method of any of aspects 14 through 19, further comprising: outputting an indication of a mapping between each sub-matrix of the plurality of sub-matrices and each respective physical resource, wherein each respective physical resource comprises a set of time resources, a set of frequency resources, a set of spatial resources, or any combination thereof, and wherein outputting the plurality of sub-matrices is in accordance with the mapping.
Aspect 21: The method of any of aspects 14 through 20, further comprising: outputting an indication of a plurality of sets of resources for each respective result vector, wherein the respective result vector is obtained via a set of resources of the plurality of sets of resources.
Aspect 22: The method of any of aspects 14 through 21, wherein obtaining the respective result vector from the one or more UEs comprises: obtaining, from a first UE of the plurality of UEs, a first result vector via a first set of resources that are according to a first downlink resource allocation of one or more first sub-matrices associated with the first UE, according to one or more first respective coding coefficients associated with the first UE, or both.
Aspect 23: The method of aspect 22, further comprising: outputting, via control signaling and to the first UE, an indication of a mapping between the first set of resources and the first downlink resource allocation.
Aspect 24: The method of any of aspects 14 through 23, further comprising: obtaining, from each UE of the plurality of UEs, a capability message indicative of whether each UE is capable of performing coded distributed computing operations, wherein outputting the information indicative of the one or more respective coding coefficients is based at least in part on obtaining the capability message.
Aspect 25: The method of aspect 24, wherein the capability message comprises a capability level of each UE of the plurality of UEs, the capability level based at least in part on a computational capability of each UE, a storage capability of each UE, or both, and a quantity of the one or more respective coding coefficients is based at least in part on the capability level.
Aspect 26: The method of any of aspects 14 through 25, wherein a quantity of the plurality of UEs is greater than a quantity of the plurality of sub-matrices of the first matrix.
Aspect 27: A UE for wireless communications, comprising one or more memories storing processor-executable code, and one or more processors coupled with the one or more memories and individually or collectively operable to execute the code to cause the UE to perform a method of any of aspects 1 through 13.
Aspect 28: A UE for wireless communications, comprising at least one means for performing a method of any of aspects 1 through 13.
Aspect 29: A non-transitory computer-readable medium storing code for wireless communications, the code comprising instructions executable by one or more processors to perform a method of any of aspects 1 through 13.
Aspect 30: A network entity for wireless communications, comprising one or more memories storing processor-executable code, and one or more processors coupled with the one or more memories and individually or collectively operable to execute the code to cause the network entity to perform a method of any of aspects 14 through 26.
Aspect 31: A network entity for wireless communications, comprising at least one means for performing a method of any of aspects 14 through 26.
Aspect 32: A non-transitory computer-readable medium storing code for wireless communications, the code comprising instructions executable by one or more processors to perform a method of any of aspects 14 through 26.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive information indicative of one or more coding coefficients of a plurality of coding coefficients, wherein the plurality of coding coefficients are associated with encoding a first matrix;
receive, via broadcast signaling, one or more sub-matrices of the first matrix and a vector, wherein each sub-matrix of the one or more sub-matrices is received via a respective physical resource, and wherein the one or more sub-matrices of the first matrix are identified according to the one or more coding coefficients; and
transmit a result vector in accordance with receiving the one or more sub-matrices, wherein the result vector is obtained according to a multiplication of a coded matrix and the vector, and wherein the coded matrix is obtained according to a combination of the one or more coding coefficients and the one or more sub-matrices.

2. The UE of claim 1, wherein:
the broadcast signaling comprises a plurality of sub-matrices that comprise the first matrix, and
the plurality of sub-matrices include the one or more sub-matrices for the UE and one or more other sub-matrices applicable to one or more other UEs.

3. The UE of claim 1, wherein:
the information indicative of the one or more coding coefficients comprises a second vector,
each element of the second vector is associated with a respective coding coefficient of the plurality of coding coefficients, and
a value of each element of the second vector indicates whether a corresponding coding coefficient is included in the one or more coding coefficients.

4. The UE of claim 1, wherein the one or more processors are individually or collectively further operable to execute the code to cause the UE to:
compute the coded matrix based at least in part on a multiply-and-accumulate operation of the one or more coding coefficients and the one or more sub-matrices; and
compute the result vector based at least in part on multiplying a result of the multiply-and-accumulate operation with the vector.

5. The UE of claim 1, wherein the information indicative of the one or more coding coefficients is received via a medium access control-control element message, a downlink control information message, a radio resource control message, or any combination thereof.

6. The UE of claim 1, wherein, to receive the information indicative of the one or more coding coefficients, the one or more processors are individually or collectively operable to execute the code to cause the UE to:
obtain a coding matrix comprising the plurality of coding coefficients; and
receive an indication of one or more rows of the coding matrix that comprises the one or more coding coefficients.

7. The UE of claim 6, wherein:
the coding matrix is obtained via a radio resource control message, and
the indication of the one or more rows is received via a medium access control-control element message, a downlink control information message, or both.

8. The UE of claim 1, wherein the one or more processors are individually or collectively further operable to execute the code to cause the UE to:
receive an indication of a mapping between each sub-matrix of the one or more sub-matrices and each respective physical resource, wherein each respective physical resource comprises a set of time resources, a set of frequency resources, a set of spatial resources, or any combination thereof, and wherein receiving the one or more sub-matrices is in accordance with the mapping.

9. The UE of claim 1, wherein the one or more processors are individually or collectively further operable to execute the code to cause the UE to:
receive an indication of a set of resources for transmitting the result vector, wherein the result vector is transmitted via the set of resources.

10. The UE of claim 1, wherein, to transmit the result vector, the one or more processors are individually or collectively operable to execute the code to cause the UE to:
transmit the result vector via a set of resources that are derived according to a downlink resource allocation of the one or more sub-matrices, according to the one or more coding coefficients, or both.

11. The UE of claim 10, wherein the one or more processors are individually or collectively further operable to execute the code to cause the UE to:
receive, via control signaling, an indication of a mapping between the set of resources and the downlink resource allocation, wherein the set of resources are derived in accordance with the mapping.

12. The UE of claim 1, wherein the one or more processors are individually or collectively further operable to execute the code to cause the UE to:
transmit a capability message indicative of whether the UE is capable of performing coded distributed computing operations, wherein receiving the information indicative of the one or more coding coefficients is based at least in part on transmitting the capability message.

13. The UE of claim 12, wherein:
the capability message comprises a capability level of the UE, the capability level based at least in part on a computational capability of the UE, a storage capability of the UE, or both, and
a quantity of the one or more coding coefficients is based at least in part on the capability level.

14. A network entity, comprising:
one or more memories storing processor-executable code; and
one or more processors coupled with the one or more memories and individually or collectively operable to execute the code to cause the network entity to:
output, to each user equipment (UE) of a plurality of UEs, information indicative of one or more respective coding coefficients of a plurality of coding coefficients, wherein the plurality of coding coefficients are associated with encoding a first matrix;
output, via broadcast signaling, a plurality of sub-matrices that comprise the first matrix and a vector, wherein each sub-matrix of the plurality of sub-matrices is output via a respective physical resource; and
obtain, from one or more UEs of the plurality of UEs, a respective result vector in accordance with outputting the plurality of sub-matrices, wherein each respective result vector comprises a multiplication of a coded matrix and the vector, and wherein each coded matrix is associated with a combination of the one or more respective coding coefficients and one or more sub-matrices.

15. The network entity of claim 14, wherein the one or more processors are individually or collectively further operable to execute the code to cause the network entity to:
obtain a computation result vector using each respective result vector obtained from the one or more UEs and a decoding matrix, wherein obtaining the computation result vector is in accordance with a quantity of obtained result matrices satisfying a threshold.

16. The network entity of claim 14, wherein:
the information indicative of the one or more respective coding coefficients comprises a second vector,
each element of the second vector is associated with a respective coding coefficient of the plurality of coding coefficients, and
a value of each element of the second vector indicates whether a corresponding coding coefficient is associated with a UE of the plurality of UEs.

17. The network entity of claim 14, wherein the information indicative of the one or more respective coding coefficients is output via a medium access control-control element message, a downlink control information message, a radio resource control message, or any combination thereof.

18. The network entity of claim 14, wherein, to output the information indicative of the one or more respective coding coefficients, the one or more processors are individually or collectively operable to execute the code to cause the network entity to:
output a coding matrix comprising the plurality of coding coefficients; and
output an indication of one or more rows of the coding matrix that comprises the one or more respective coding coefficients.

19. The network entity of claim 18, wherein:
the coding matrix is output via a radio resource control message, and
the indication of the one or more rows is output via a medium access control-control element message, a downlink control information message, or both.

20. The network entity of claim 14, wherein the one or more processors are individually or collectively further operable to execute the code to cause the network entity to:
output an indication of a mapping between each sub-matrix of the plurality of sub-matrices and each respective physical resource, wherein each respective physical resource comprises a set of time resources, a set of frequency resources, a set of spatial resources, or any combination thereof, and wherein outputting the plurality of sub-matrices is in accordance with the mapping.

21. The network entity of claim 14, wherein the one or more processors are individually or collectively further operable to execute the code to cause the network entity to:
output an indication of a plurality of sets of resources for each respective result vector, wherein the respective result vector is obtained via a set of resources of the plurality of sets of resources.

22. The network entity of claim 14, wherein, to obtain the respective result vector from the one or more UEs, the one or more processors are individually or collectively operable to execute the code to cause the network entity to:
obtain, from a first UE of the plurality of UEs, a first result vector via a first set of resources that are according to a first downlink resource allocation of one or more first sub-matrices associated with the first UE, according to one or more first respective coding coefficients associated with the first UE, or both.

23. The network entity of claim 22, wherein the one or more processors are individually or collectively further operable to execute the code to cause the network entity to:
output, via control signaling and to the first UE, an indication of a mapping between the first set of resources and the first downlink resource allocation.

24. The network entity of claim 14, wherein the one or more processors are individually or collectively further operable to execute the code to cause the network entity to:
obtain, from each UE of the plurality of UEs, a capability message indicative of whether each UE is capable of performing coded distributed computing operations, wherein outputting the information indicative of the one or more respective coding coefficients is based at least in part on obtaining the capability message.

25. A method for wireless communications at a user equipment (UE), comprising:
receiving information indicative of one or more coding coefficients of a plurality of coding coefficients, wherein the plurality of coding coefficients are associated with encoding a first matrix;
receiving, via broadcast signaling, one or more sub-matrices of the first matrix and a vector, wherein each sub-matrix of the one or more sub-matrices is received via a respective physical resource, and wherein the one or more sub-matrices of the first matrix are identified according to the one or more coding coefficients; and
transmitting a result vector in accordance with receiving the one or more sub-matrices, wherein the result vector is obtained according to a multiplication of a coded matrix and the vector, and wherein the coded matrix is obtained according to a combination of the one or more coding coefficients and the one or more sub-matrices.

26. The method of claim 25, wherein:
the broadcast signaling comprises a plurality of sub-matrices that comprise the first matrix, and
the plurality of sub-matrices include the one or more sub-matrices for the UE and one or more other sub-matrices applicable to one or more other UEs.

27. The method of claim 25, wherein:
the information indicative of the one or more coding coefficients comprises a second vector,
each element of the second vector is associated with a respective coding coefficient of the plurality of coding coefficients, and
a value of each element of the second vector indicates whether a corresponding coding coefficient is included in the one or more coding coefficients.

28. A method for wireless communications at a network entity, comprising:
outputting, to each user equipment (UE) of a plurality of UEs, information indicative of one or more respective coding coefficients of a plurality of coding coefficients, wherein the plurality of coding coefficients are associated with encoding a first matrix;
outputting, via broadcast signaling, a plurality of sub-matrices that comprise the first matrix and a vector, wherein each sub-matrix of the plurality of sub-matrices is output via a respective physical resource; and
obtaining, from one or more UEs of the plurality of UEs, a respective result vector in accordance with outputting the plurality of sub-matrices, wherein each respective result vector comprises a multiplication of a coded matrix and the vector, and wherein each coded matrix is associated with a combination of the one or more respective coding coefficients and one or more sub-matrices.

29. The method of claim 28, further comprising:
obtaining a computation result vector using each respective result vector obtained from the one or more UEs and a decoding matrix, wherein obtaining the computation result vector is in accordance with a quantity of obtained result matrices satisfying a threshold.

30. The method of claim 28, wherein:
the information indicative of the one or more respective coding coefficients comprises a second vector,
each element of the second vector is associated with a respective coding coefficient of the plurality of coding coefficients, and
a value of each element of the second vector indicates whether a corresponding coding coefficient is associated with a UE of the plurality of UEs.
